(19) United States
(12) Patent Application Publication
(10) Pub. No.: US 2013/0262092 A1
(43) Pub. Date: Oct. 3, 2013

(54) Narrative Generator

(71) Applicant: Steven Wasick, Chicago, IL (US)

(72) Inventor: Steven Wasick, Chicago, IL (US)

(73) Assignee: FANTASY JOURNALIST, INC., Chicago, IL (US)

(21) Appl. No.: 13/855,700

(22) Filed: Apr. 2, 2013

Related U.S. Application Data
(60) Provisional application No. 61/619,346, filed on Apr. 2, 2012.
(60) Provisional application No. 61/776,206, filed on Mar. 11, 2013.

(51) Int. Cl. G06F 17/28

(52) U.S. Cl. CPC G06F 17/28
USPC 704/9

(57) ABSTRACT

A narrative generator includes a processor is configured to: implement a plurality of writers to create a plurality of narrative blocks related to selected topic paragraph creators, each writer including a plurality of text options from which a narrative block is constructed, wherein text options are selected for inclusion in a given narrative bock are based at least in part on reference to a narrative companion array and a grammar companion array, wherein the narrative companion array includes semantic values corresponding to the data elements included in any of the plurality of narrative blocks, wherein the grammar companion array includes grammar values associated with the text options included in the plurality of narrative blocks.

### BACKGROUND OF THE INVENTION

The present subject matter relates generally to systems and methods for automatically presenting data in a narrative form. More specifically, the present invention relates to automated systems and methods through which fully developed journalistic narratives are developed from one or more factual databases without requiring human intervention.

As the amount of data in the world increases, there is a need for an automated method of presenting data in narrative form. Other methods have attempted to do this by creating pre-made templates that can be fitted to sets of data; grown up versions of the children's games sold under the trademark Mad Libs. One key problem in creating template-based narratives is the almost limitless combinations of potential sentences that make up a template. The combination problem is due to the fact that every sentence in a narrative, or even parts of a sentence, is often independent from each other sentence. This means that the number of combinations in a given narrative is equal to or greater than the number of possible sentence options raised to the power of the number of sentences written. In a typical journalistic article, this is an unmanageable number.

For instance, picture a five-sentence article describing a sports game, where each sentence describes a particular aspect of the game (1st sentence: score, 2nd sentence: the records of the teams, etc.) For illustrative purposes, we will say that each sentence has exactly ten possibilities. The sentence describing the score would have ten different versions depending on whether the score was blowout, close game, high scoring, low scoring, etc. With only five sentences, and only 10 possibilities for each sentence, this creates 100,000 possible combinations (10̂5). A sports article of 500+ words has many more than five sentences, and many of those sentences have more than ten possibilities. Without some way of dealing with this problem, a narrative assembly program that used templates would either be impracticably large (needing a unique template for each possibility) or would be very limited in its application.

Accordingly, there is a need for systems and methods for automatically presenting data in a narrative form, as described herein.

### BRIEF SUMMARY OF THE INVENTION

To meet the needs described above and others, the present disclosure provides systems and methods for automatically presenting data in a narrative form. The solutions presented herein build the narrative from the ground up. The narrative generator starts by identifying all of the storylines that apply to given set of data. It then assigns each of those storylines a value commensurate with its importance in describing the data. By looking at each discrete storyline independently, the narrative generator avoids the exponential problems that occur when trying to identify combinations of data.

However, looking at each storyline independently creates a new problem; once the appropriate storylines applicable to a given set of data have been identified, and an interest level assigned, the narrative generator must assemble those storylines into a coherent narrative. This is difficult because a simple recitation of each storyline would result in a robotic, bland narrative. Real narratives ebb and flow, with sentences that transition to each other and play off of what past and future sentences say. Unfortunately, if the different sentences in the article are tied into each other directly, by using combinations of pre-written templates for instance, that re-introduces the problem of interdependence, which then re-introduces the problem of dealing with exponential numbers of combinations.

The solutions presented herein break the narrative assembly into discrete levels, each having its own isolated decision algorithm, and imbues each of those levels with the independent intelligence needed to create human level narratives. The intelligence takes the form of arrays that store semantic data about the content in the narrative in such a way that other parts of the narrative generator understand the context that each part of the narrative is being constructed in, and adjust the narrative accordingly. In one embodiment, there are six levels; (1) narrative, (2) topic, (3) theme, (4) storyline, (5) phrase, and (6) word. Since each of these levels are not directly connected to each other, the decision making process is not subject to the ruinous exponential combination problems that occur when a single procedure is trying to work through all of the possibilities for an article or paragraph.

In some embodiments, the systems and methods provided herein may be used to create a narrative of comparable depth and scope to one that could be created by a human being. These narratives can vary in length, but are capable of containing over 500 words. The narrative produced can become part of a series of narratives or a layout presenting multiple narratives at once, as in a newspaper-like front page.

One embodiment uses a narrative generator to create a narrative that describes a fantasy sports contest. This particular embodiment will be used frequently in the descriptions presented herein to illustrate specific ways in which the solutions may be implemented. However, the solutions presented herein are applicable to a wide range of uses, including any instance where data needs to be turned into a narrative, such as for news generation, video game dialog, or other uses. Depending on the complexity of the underlying events being reported on, the narrative generator may be used to generate entire articles, or to generate “stub” articles containing numerous possible storylines that could then be modified and improved upon by human journalists. It could also be used as a tool that helps reporters or business people identify storylines for a given set of data. For instance, a sports reporter tasked with writing a recap for a game could use the narrative generator to identify storylines related to the history between the two teams playing.

The solutions presented herein are embodied in a narrative generator. Variations of the preferred embodiments of the narrative generator are provided in the following descriptive summary. The narrative generator is implemented by a processor that executes program instructions stored in memory. The processor may access one or more databases of facts as the basis of the narrative generation as described further below. The features and functions of the processor, memory, and databases are conventional in nature and will be understood by those skilled in the art based on the teachings provided herein.

In implementing the narrative generator, the processor receives a data set comprising a plurality of data elements as input. The data set is sent to a statistics aggregator that categorizes and stores each data element in the memory, wherein each data element is associated with at least one category tag.

In addition to categorizing and storing each data element, the statistics aggregator may optionally create further data elements through an analysis of the data set. For example, a first data element and a second data element both included in the original data set may be compared to create a third data element that was not originally included in the data set. Any data elements created by the statistics aggregator may further be stored in memory and associated with at least one category tag. These additional data elements may be generated by a comparative analysis of original data elements, a combinatory analysis of the original data elements, a subtractive analysis of the original data elements, etc. Even further, additional data elements may be generated based on comparisons, combination, etc. involving other additional data elements.

A story matrix creator identifies a plurality of identified storylines from stored data elements. A storyline is a narrative that describes one aspect of the data (e.g., “Team X plays a good opponent next week,” “Team Y had a comeback win this week,” “Coach A left the top performer on the bench last week,” etc.). The story matric creator identifies each storyline by analyzing the data elements in light of a storyline sub-routine associated with each potential storyline. For example, if Team X scored more points than Team Y, identify the storyline “Team X won” and do not identify the storyline “Team Y won.” The story matrix generator may include a story matrix for each team, for each player, for each coach, etc.

The story matrix creator further assigns an interest value to each identified storyline. The interest value is a representation of how interesting the storyline may be. For example, a 50 point win and a 65 point win may both trigger a “large blowout” storyline, but the 65 point win may be assigned a higher interest value. The interest value is assigned by an interest value function that is included in the story matrix generator.

The story matrix creator also assigns a semantic value to each identified storyline. Semantic values are both specific and generalized thematic values. For example, a semantic value may be something specific, like “team got lucky,” or something generalized, like “good” or “bad.” Semantic values are triggered by identified storylines. For example, the identified storyline “Team X won” may trigger the assignment of the sematic values of “good” and “team did well.” Sematic values may be binary (i.e., on or off) or they may be qualitative (i.e., an assigned value as a percentage of a maximum value).

Once the story matrix creator has identified the storylines and assigned an interest value and semantic value to each, the theme matrix creator identifies potential narrative themes. Just as the story matrix creator identifies storylines from the data elements, the theme matrix creator identifies narrative themes from the identified storylines. The theme matrix creator may also assign an interest value and semantic value to each identified narrative theme. In one example, if the identified storylines include “Team X is on a losing streak” and “Team Y is on a losing streak” the theme matrix creator may identify the narrative theme “both teams on losing streaks.”

The theme matrix creator may be run numerous times throughout the process to further refine the use of narrative themes in the narration.

After the storylines and narrative themes have been identified, the narrative selects from amongst the identified storylines and narrative themes and assembles them into a natural sounding narrative by calling sub-routines responsible for varying levels of the narration: narrative; topic; theme; storyline; phrase; and word. For example, the narrative generator may include sub-routines including a narrative layout creator, a topic paragraph creator, a theme writer, a storyline writer, a phrase writer, and a word writer.

The narrative layout creator performs the first level of the narrative assembly. The narrative layout creator may identify headlines, media, and sidebars, as well as organize and order the conditions under which the topic paragraph creator is called.

The narrative layout creator identifies headlines, for example, by identifying the identified storyline with the highest interest value. When there is a series of narratives, the narrative layout creator may also take into consideration previously identified headlines so as to create diversity in the series of narratives.

The narrative layout creator may include a headline writer, including a main headline writer and a sub-headline writer. The main headline writer may identify a main headline from a plurality of possible main headlines wherein the selected main headline has a relationship with the identified storyline with the highest interest value. The sub-headline writer may identify the sub-headline similar to the process described for the main headline writer. While main headlines may typically be short, witty statements, sub-headlines are typically more substantive.

The headline writer may also include a visual media selector. The visual media selector may identify one or more visual media elements corresponding to the headline(s). The visual media elements may be stored in association with meta-data that identifies the subject of the visual media, as well as contextual descriptors, such as positive, negative, etc. For example, if the identified main headline references a player in a positive light, the visual media selector may select a visual media element with meta-data that identifies the referenced player in a positive light.

Custom elements may be incorporated into the narrative generator at varying levels of the narrative assembly. For example, custom writers may be used to provide and select custom headlines and provide and select custom visual media. For example, custom elements may be incorporated into the narrative assembly such as a custom headline written by a non-technical writer. The inclusion of custom elements may increase the flexibility and responsiveness of the narrative generator.

The narrative layout creator may also include a sidebar writer that creates one or more sidebars as part of the narrative assembly. A sidebar is a visual representation of data that accompanies the verbal narrative. For example, the sidebar writer may identify the identified storyline referencing a statistics based data element with the highest interest value. The sidebar writer may then call on a sidebar template to express the data elements from the identified storyline in a sidebar format.

The narrative layout creator may further include a global theme selector. The global theme selector may identify recurring themes in the semantic values of the identified storylines and select a global theme. For example, if many of the identified storylines have a semantic value of good luck, a global theme may be good luck. The other sub-routines may base one or more of their actions on the selected global theme or themes, as will be understood by those skilled in the art based on the disclosures provided herein.

After creating/identifying/selecting the headlines, sub-headlines, visual media, sidebars, and global theme(s), the narrative layout creator selects the appropriate topic paragraph creators and determines the order they are to be selected. The narrative layout creator may choose different arrangements of topic paragraph creators based on the types of headlines, the number of particular storylines that have been identified, and the interest value of those storylines, and other factors, such as a general need for variety in the format of narratives that are seen repeatedly. After choosing the order and type of topic paragraph creators to be called, the narrative layout creator calls each of the topic paragraph creators.

Topic paragraph creators are sub-routines of the narrative generator that assemble the portions of the narrative around a particular topic. Each topic paragraph creator may create a paragraph, create more than one paragraph, or add to an existing paragraph. The topic paragraph creators may further identify where paragraph breaks should occur, for example, based on the order and length of the identified storylines and theme elements.

Topic paragraph creators may create “additive” or “consistent” paragraphs. Additive paragraphs are those in which the number of relevant storylines may be between zero and a large number. For example, a paragraph generated by a topic paragraph creator concerning coaching mistakes may be an additive paragraph, because there may have been no coaching mistakes, or there may have been quite a few coaching mistakes. Consistent paragraphs are those based on storylines that consistently occur in writing regarding certain subjects. For example, narratives concerning fantasy football may consistently include storylines that describe which team won, how players did relative to their projected points. The topic paragraph creators may work differently depending on whether they are assembling paragraphs that are additive or consistent in nature.

When creating “additive” paragraphs, a topic paragraph creator may need to determine which additive storylines to include in the narrative. One way of doing so is using the interest values and semantic values assigned to each storyline by the story matrix creator. The topic paragraph creator may include a sub-topic array that triggers the inclusion of specific storylines. The sub-topic array may include a plurality of storylines in a plurality of sub-topic buckets. Each sub-topic bucket includes storylines whose semantic value matches the associated sub-topic. For example, one sub-topic bucket may include each of the storylines that include a semantic value of “playoffs.” Each of the sub-topic buckets may include a corresponding interest value. Accordingly, each storyline may have an interest value assigned by the story matrix creator and another interest value provided by the sub-topic array bucket with which it is associated.

For storylines whose semantic value is appropriate for the paragraph being created, the sub-topic array may trigger storyline inclusion based on the interest values assigned to each storyline. The topic paragraph creator may set a higher or lower cutoff for the minimum interest value to determine whether to include a storyline in the paragraph based on the number of storylines that would be triggered in the sub-topic array. For example, if the paragraph length would be too long, the minimum interest value for the cutoff may be raised. The topic paragraph creator may look at each interest value associated with each storyline when making the determination of whether to include the storyline in a given “additive” paragraph.

In a “consistent” paragraph, certain types of storylines have the potential to appear every time, whether or not they are important for telling the narrative. For instance, when writing a paragraph about what happened during Sunday afternoon games between two fantasy football teams, one team will have scored more than the other, or they will have both scored the same amount. Every player who played will have scored more, the same, or less points, than was expected. However, some of these storylines are more relevant to the overall narrative and it may be preferred to include only the most relevant storylines. For instance, one team may have outscored the other team during a particular time period, but that storyline may not be important to the narrative if the game is already essentially over (by contrast, it would be of critical importance if the game was close and not complete). The main challenge of the topic paragraph creator when assembling a “consistent” paragraph is to determine which of the consistently appearing storylines are relevant to the narrative.

To deal with this problem, the topic paragraph creator uses paragraph framers to call appropriate storylines into the paragraph. Paragraph framers function essentially as mini-topic paragraph creators that are more likely to call storylines matching the paragraph framer's purpose. For example, if a matchup between two fantasy football teams is concluded, the topic paragraph creator may call a paragraph framer adapted to describing time periods where the outcome of the game is already determined. This paragraph framer might then only call the storylines related to “concluded” narratives.

Additionally, paragraph framers can be configured to write paragraphs with a given semantic value (i.e., themes). These paragraph framers are referred to as story seeds. Story seeds include one or more seed spots that provide a semantic value that may trigger the use of the story seed. For example, a given story seed may include three seed spots, each with a respective semantic value: “can be lead coach story;” “can be main coach story;” and “can be context coach story. The story seed scans through the list of triggered storylines to see if there are storylines that have the matching semantic values. If so, it places them into the matching seed spot. If there is more than one storyline that fits into a given seed spot, the story seed can create two of more copies of itself in order to reflect all of the possible combinations of storylines that can fit into the story seed. Alternatively, it could just select the storyline with the highest interest value. Each seed spot may include properties that dictate seed spot usage. For example, a given seed spot may include the seed spot property “must be used,” which may indicate that the story seed must find a storyline that fits into that seed spot if the story seed overall is to be deemed triggered. Another property may be the story seeds relationship with other storylines, story seeds, and seed spots, etc. For example, if a first two seed spots that relate to a given player have been triggered, a third seed spot's properties may require that the third seed spot also refer to that given player.

The story seeds can call on storylines whose semantic values match that of the story seed. In addition, story seeds themselves may include semantic values such that the story seeds may be assembled into a group in a similar fashion to how storylines are assembled by storylines.

The topic paragraph creator may include a filter level that is used to assemble paragraphs. The filter level is a cutoff system that excludes storylines whose interest level does not meet or exceed a threshold amount. The filter level may start at a baseline level that is then subsequently adjusted as thematic narrative elements are put into place. For example, once a particular narrative element is set (e.g., the game is out of reach for the team trailing), the filter level may adjust to exclude storylines that may no longer be as relevant.

After the topic paragraph creator selects the storylines for inclusion in the paragraphs and chooses the paragraph themes, the topic paragraph creator calls upon theme writers and storyline writers to write the words for the narrative. The theme writers and storyline writers may call on phrase writers and word writer to assist in the process. The theme writers, storyline writers, phrase writers, and word writers, collectively the writers, compose narrative blocks. Narrative blocks are at least one sentence long, but may be more than one sentence. Narrative blocks include narrative block text, punctuation, and formatting that will be published as the narrative output. The narrative blocks are stored in a narrative bock array.

The writers are a series of text options, wherein one option is selected by the writer logic to meet the needs of the narrative. The text options may be fixed text (e.g., “The game was over by Monday night”), may be text including variables (e.g., [Team X] did well Sunday afternoon.”), or may call on lower level writers (e.g., [Team X] & phraseTeamPerformance & phraseWhatTime.”). In some embodiments of the narrative generator, each option in a writer includes the same basic narrative information, but is phrased differently to enable the writer to select the construction that fits the context of the narrative best.

To determine the best text option to select, the writer logic analyzes information included in other narrative blocks and information from the statistics aggregator. For example, a storyline writer relating to the storyline “team's upcoming opponent is on a losing streak” might include a first text option that states, “[Team A] should have an easy time next week as [Team B] will come into the game on a [X] game losing streak.” However, the writer logic for that storyline writer may check to see if a previous narrative block already mentioned the upcoming team being a weak opponent (as described further herein). If such a statement had previously been made, the writer logic could select a different text option, one more appropriate for the narrative as a whole. For example, the more appropriate text option may state, “In addition, [Team B] will come into the game on a [X] game losing streak.”

After the writer logic identifies the appropriate text option and adds it to the narrative block, the writer logic adds the appropriate semantic information to a narrative companion array and a grammar companion array. These arrays are examples of semantic value arrays that enable the writers to select more appropriate text options to improve the overall cohesiveness of the narrative.

The narrative companion array stores semantic elements that correspond to each narrative block. For example, these semantic elements may include “mentions other team,” “mentions team got lucky,” “this narrative block is a theme,” etc. These semantic elements are triggered, or activated, by the writers when text options are selected. Each text option available in a given writer may trigger identical semantic elements, overlapping, but non-identical semantic elements, or mutually exclusive semantic elements.

Narrative companion arrays are critical to allow each writer to operate independently while creating content that is coherent in the context of the greater narrative. Although the list of possible semantic elements may be very long, each individual writer only needs to check the narrative companion array for those semantic elements that are relevant to the writer's content. For instance, a storyline writer that deals with a team having injury concerns might include a text option that reads, “Coach X was dealing with injury issues.” However, before selecting this text option, the writer logic for the storyline writer may look at the narrative companion array to determine whether a previous narrative block relating to the other team had triggered the semantic element “team dealing with injuries.” If so, the writer logic could select an alternative text option that reads, “Coach X was also dealing with injury issues.” However, each writer would not need to have separate text options corresponding to every combination of semantic elements in the narrative companion array because most of those semantic elements would have no effect on the optimal content for the writer to produce.

The grammar companion array stores various grammar values relating to the grammatical content of the words and phrases used in the narrative. The grammar companion array enables the various writers to choose coherent text options. For example, if the phrase “even better” is used in an existing narrative block, the semantic element corresponding to the phrase “even better” is triggered in the grammar companion array associated with that narrative block.

Each of the writers can access the grammar companion arrays to identify aspects of previous narrative blocks that conflict with what the writer may select. Each writer only needs to check those elements that would potentially conflict with what the writer intends to write. For instance, a writer that is using the phrase “even better” would check to see if the previous narrative block uses that phrase by checking the corresponding grammar companion array. If the previous narrative block includes the phrase “even better,” the writer then selects a text option that does not include the phrase “even better.”

The grammar companion array can also be used to identify the form and tense of a particular narrative block. This is useful for when a particular narrative block is being constructed by multiple different writers, each of which is independent from each other. Without adding intelligence to the narrative generator through the use of the grammar companion array, the resulting narrative block could end up jumbled. For instance, certain terms, such as “meanwhile” indicate that the rest of the sentence is in the “past progressive” form and tense.

Accordingly, a storyline writer may begin construction of narrative block by using a phrase writer that identifies that the action described by the current narrative block took place at the same time as the previous narrative block. Accordingly, this phrase writer may start the narrative block with the phrase “Meanwhile,” and mark the semantic element in the grammar companion array that identifies this narrative block as being in the “past progressive” tense. The storyline writer would then pass the generation of rest of the narrative block to other phrase writers and word writers. Despite not having any direct connection to the phrase writer that wrote “Meanwhile,” the other writers could use the information contained in the grammar companion array to understand the proper form and tense of the narrative block and write their individual portions using appropriate grammar by selecting text options available to them that are in the proper tense and form.

In some embodiments, after selecting which storylines and theme elements to use, and identifying the order they will be called, the topic paragraph creator calls the theme writer associated with the theme elements the topic paragraph creator has selected. Theme writers are used to place storylines into the appropriate context. Theme writers can set the scene for an entire paragraph, or simply tie two storylines together. An example of a theme is that both coaches in a fantasy sports match-up have storylines that involved poor decisions. The theme writer might then create a narrative block with narrative block text that reads: “Both coaches made bad decisions this week.”

In some embodiments, after writing the narrative block to the narrative block array, the theme writer triggers any appropriate semantic information in the narrative companion array and grammar companion array.

As described above, when writing individual storylines, the narrative generator uses a storyline writer. Each storyline in the story matrix has its own dedicated storyline writer that writes a narrative block appropriate for the particular storyline. For instance, in one embodiment, a specific storyline is triggered when a team does not have any players in the top 20 for fantasy points for the year. The storyline writer associated with this storyline might select a text option that states: “[Team X] currently has no players in the top twenty in total points.” These words might constitute the entire narrative block, in which case the storyline writer would add the text to the narrative block.

Storyline writers can be simple or complex. Certain storylines, when written out by a storyline writer, include similar words regardless of the context in which the storyline is written. For these storylines, the storyline writer writes the words of the narrative block, as in the example given above. Other storylines will be so dependent on context that the storyline writer essentially only sets up the structure of the narrative block and relies on phrase writers and word writers to generate the actual content. For instance, a storyline writer for a storyline that is describing how a team performed during a particular time period might include a text option that looks like this: “phraseMeanwhile( ) & phraseWhatTimePeriod( ) & phraseTeamPerformance( )”.

After the storyline writer generates the appropriate text (either directly or by receiving text from phrase writers and word writers), the storyline writer adds the text as the narrative block text in the narrative block that it is working on and the storyline writer triggers the appropriate semantic elements in the associated narrative companion array and grammar companion array.

Theme writers and storyline writers use phrase writers to write the sub-parts of a narrative block that are subject to a significant amount of variation. Phrase writers return a text option selection and appropriate semantic information that is then incorporated into a narrative block by theme writers or storyline writers. Typically, the phrase writer is used to create only part of a sentence, but in some instances the phrase writer can be used to create a whole sentence, particularly when the sentence is part of a multiple sentence narrative block.

As an example, a phrase writer can help put together the narrative block corresponding to the storyline that states that a fantasy sports team has done well during a particular time period. That team might have done well because one player had a good game, two players had a good game, one player had a great game that offset another player's bad game, etc. Since these various kinds of performances might only be one part of the narrative block, the storyline writer may call a phrase writer to generate the appropriate phrase relating to the player performance that led to the good result. The code corresponding to the text option for the storyline writer may look something like this:
Text Option #1=“[Team A] had a great performance in the afternoon,” & phrasePerformanceExplanation(afternoon, team A)

When the phrase writer “phrasePerformanceExplanation” is called, the writer logic for the phrase writer sorts through the data generated by the statistics aggregator and determines which text option, out of a list of text options, most accurately describes the data. In this embodiment, the text options would all be similar types of narratives, but would potentially be inconsistent with each other.

In other embodiments, all of the text options of a phrase writer may be consistent with each other. In such an example, the phrase writer is used to select the most appropriate phrase from a series of synonymous phrases in order to improve the narrative quality. For instance, the phrase writer uses the grammar companion array to determine if a similar phrase has been used recently in the narrative and selects a text option that does not use the same words included in the previous phrase.

Phrase writers including inconsistent text options and phrase writers including synonymous text options are not mutually exclusive. In some embodiments, one phrase writer uses its writer logic to determine which text option best fit the data from the statistics aggregator, and then the selected text option includes a call to another phrase writer that includes a series of synonymous phrases as text options, and the phrase writer determines which of the synonymous text options to select.

Word writers are used to write words in ways that are grammatically accurate and contribute to narrative flow. Word writers are called by writers higher up in the hierarchy of the narrative generator (i.e., theme writers, storyline writers, and phrase writers) to select a text option and trigger appropriate semantic information in associated narrative companion arrays and grammar companion arrays. Word writers are specific to a word or a pair of words. For instance, a phrase writer may use the phrase “was having a great afternoon” to describe a good performance. However, the beginning of the narrative block may be organized in such a way that the use of the verb “was having,” which is in the past progressive tense, is inappropriate. A word writer for the verb “have” can be called up to identify the proper form and tense of the narrative block and insert the appropriate verb tense and form.

In some embodiments, the word writer can be used for adjectives. The word writer can change the adjective based on concerns such as the recent use of the same adjective in other narrative blocks, or selecting different adjectives that have not been overused in other narratives that are part of a series, such as the yearlong reporting of a fantasy sports league. For instance, if a phrase writer contains the phrase “was doing terrible,” the word “terrible” can be written by a word writer, which would select from a bank of text options that are synonymous with the word “terrible.”

Like the headline writer described above, all writers can take advantage of custom writers. Writers can check to see if there are custom elements to be incorporated into the narrative block text. For instance, a storyline writer that talks about a player's good performance could check to see if there is a custom element involving that player that would be relevant to their performance, such as the fact that the player was injured. The storyline writer may include a text option written to incorporate a custom phrase involving injury, and the writer logic may select this text option and incorporate the custom phrase. The text option code may look like this:
Text Option #1: “[Player X] shook off his” & customInjuryWriter(Player X) & “and dropped [Y] points.”

This text option may produce a narrative block text that reads: “Player X shook off his sore ankle and dropped 30 points.”

The examples provided above describe a top down structure of storyline identification and assembly, wherein topic paragraph creators call storyline writers. Building on these examples, each individual storyline writer may use context calls to generate additional appropriate narrative blocks. A context call occurs when a storyline writer calls another storyline writer directly. For instance, a storyline writer that writes a narrative block relating to “player X over performed and won the game” may check to see if the storyline element for “player X is on a streak of over performance” is triggered in the player story matrix. If it is, the storyline writer for “player X is on a streak of over-performance” can be called directly from the storyline writer for “player X over performed and won the game.” If one storyline writer calls another storyline writer with a context call, that is a “Level 1” context call. If that storyline writer then calls another storyline writer with a context call, that is a “Level 2” context call and so on. The context level is reset to 0 once the topic paragraph creator calls a storyline writer directly.

To keep this system from running wild and potentially creating a narrative with too much detail and context, the article layout creator can place a cap on the number of context calls by setting a context calls max and also setting a context levels max. The context calls max is a variable that sets a limit on the absolute number of context calls that are allowed to occur in the narrative. The context level max is a variable that sets a limit on the maximum context levels that are allowed. The context calls max and the context levels max can be set either on a global basis, applying to the entire narrative, or can be set to only apply to particular topic paragraph creators.

The narrative generator may be adapted to dynamically change the average length of the narratives it creates through any one or more of the following various methods. First, the narrative layout generator can call a greater or lesser numbers of topic paragraph creators. Second, for additive paragraphs, the topic paragraph creators can reduce or expand the number of different sub-topics allowed to be discussed in the paragraph. Third, for consistent paragraphs, the topic paragraph creators can start with a lower or higher filter level value, allowing different amounts of content to be deemed important for the narrative. Fourth, the article layout creator can limit or expand the levels and number of context calls.

The narrative generator can also integrate open-ended information from human sources after the narrative has been written. It does this by using the automated interviewer. The automated interviewer identifies certain storylines for which acquiring additional information about those storylines from human readers may benefit the narrative. The automated interviewer can be adapted to use the interest values of the storylines to determine which storylines to pose questions about. Alternatively, in some embodiments, the automated interviewer may determine which storylines to pose questions about by looking for particular semantic elements in each storyline element's semantic value array.

In one embodiment, each storyline element includes a dedicated storyline interviewer that includes a question, or multiple questions, related to the storyline. For instance, if there is a storyline that concerns a player doing well, the storyline interviewer dedicated to that storyline may include the question: “What do you think about player X's performance?” In addition to the question that is posed to the interviewee, the storyline interviewer may include a phrase that is a summary of the question posed. For example, the summary phrase for the question “What do you think about player X's performance” could be: “When asked about player X's performance, Coach A said.” This phrase will be incorporated with the interviewee response to create a new narrative block to be inserted after the narrative block that includes the storyline element identified by the automated interviewer. In some embodiments, when adding the new narrative block, the storyline interviewer makes grammar changes such as making sure there is a period at the end of the interviewee response, or changing the capitalization of the first letter of the interviewee response. In some embodiments, the interviewee will be able to select from a list of semantic values that can be attached to his/her interviewee response. These values can then be used by the narrative generator to incorporate the response into the narrative.

In some embodiments, when a reader is viewing the narrative, an interview marker appears next to the part of the narrative where the automated interviewer has identified a narrative block that includes a storyline element that is ripe for an interview question. In some embodiments, the interview marker only appears to certain readers. For instance, in the fantasy football example, the interview marker may only appear if the coach to be interviewed is the one viewing the narrative.

As an example, in one embodiment, if a fantasy team owner is reading an article about his own team, the automated interviewer places an interview marker next to the storyline element for which it wants additional information. When the fantasy owner clicks on the marker, the storyline interviewer asks a question that is relevant to that storyline element. For instance, if the storyline element concerns a particular player on an underperforming streak, the question from the storyline interviewer might read: “Coach X, player A underperformed yet again in this week's contest, what do you think about that?” The response from the coach is recorded as the interviewee response. The storyline interviewer then combines this response with the phrase that summarizes the question posed (e.g., “When asked about player A's continuing underperformance, Coach X said”) and add this text as the narrative block text for a new narrative block. This narrative block is then added to the narrative block array in the position immediately following the narrative block identified by the automated interviewer identified. All of the other narrative blocks in the narrative block array are pushed down one space and the narrative is ready for republishing.

In some embodiments, after all of the topic paragraph creators have been called by the narrative layout creator, all of the narrative blocks stored in the narrative block array are published as the narrative output. The narrative output represents the final presentation of the text and visual information created by the narrative generator.

In some embodiments, a narrative output arranger acts on the finished narrative block array, along with any headlines, pictures, and sidebars, to arrange the narrative and visual information generated by the narrative generator into a form that is more pleasing to the reader. For instance, the narrative arranger could make sure the headlines appear before the body of the narrative, and that sidebars appear next to the storyline element that they were derived from.

In some embodiments, the narrative output arranger selects one “top headline” out of several headlines that were generated by the narrative generator for each of several narratives. This “top headline” may be selected for having the highest interest value or for other factors, depending on the requirements of narrative presentation. In this embodiment, the narrative output arranger might show the top headline, along with the visual media file associated with it, for only one narrative, and show the sub-headlines for all the other narratives. This type of presentation mirrors the presentation format currently used on many news websites.

In some embodiments, information created by the narrative generator (such as narrative blocks and data from the statistics aggregator) can be stored as stored narrative information, so that the information contained therein can influence a subsequent narrative created by the narrative generator. This may help narratives that are generated in a series to avoid undue repetition, such as avoiding the selection of a headline that is exactly the same as a headline generated in the previous narrative.

Furthermore, the stored narrative information may be adapted to allow the narrative generator to act as an external data for a narrative generator that is creating a different type of narrative. For instance, in a fantasy sports league, one narrative generator could be used to generate articles on what happened in each week's fantasy sports match-ups. A different narrative generator could be used to write articles about the league itself, and how it compares to other leagues for which the narrative generator is writing articles. It could do this by accessing the stored narrative information left by the “match-up” narrative generator and using that information as its external data source. Such an article might point out that “good coaching” stories were written up more often in this particular league than they were in the average league.

In the above-described embodiment, the various elements, such as theme writers, story writers, phrase writers, word writers, and semantic tags, are all described as separate function types. The semantic elements, for instance, are stored in array, and can be set as on or off. An alternative embodiment takes all writing functions and semantic elements and turns them into storycom objects.

Storycom objects are programming objects created in an object-oriented programming language. Storycom is short for “story communicator,” as each storycom object helps to facilitate the creation of a narrative. In a preferred embodiment, there are four basic types of storycoms:
1. storywriter storycoms that write stories, such as “player had a great performance;”
2. word storycoms that write individual words, such as the verb “to be;”
3. concept storycoms that hold concepts, such as “is good,” which can then be attached to other storycoms (like storywriter and word storycoms); and
4. intelligence storycoms that help alter the content of storywriter storycoms, as described in more detail below.

Although different in function, each storycom object has the same basic capabilities. Every storycom object includes two lists which include other storycoms. One of the lists is called its inheritance basket. The inheritance basket includes all of the attributes that are inherent to the storycom object. For instance, a storywriter storycom about a player doing well this week would have the concept storycoms for “doing well” and “concerns this week” in its inheritance basket. This allows other parts of the program to interact with the storycoms intelligently, just as they would with the semantic element arrays.

The advantage over the array-based semantic elements stems from the fact that each concept storycom includes its own inheritance basket, allowing for hierarchical understanding. For instance, the “concerns this week” concept storycom may include a “concerns specific time period” storycom in its inheritance basket. Each storycom inherits not only what is in their inheritance basket, but all of the inherited properties that the storycoms in their inheritance basket have, and so on. Therefore, although there would be no “concerns specific time period” storycom in the “player doing well this week” inheritance basket, the software would know that it includes that concept, since the “concerns this week” storycom includes that concept in its inheritance basket. This makes it easy to create hierarchical concepts, and also makes things much easier to program. For instance, many baseball statistics have the attribute of being “countable” (as opposed to averages or rates). Each baseball statistic storycom (which are “word” storycoms) adds the “countable” concept storycom to its inheritance basket. If at some point the programmer decides that all countable stats do not require an indefinite article (unlike, e.g., “he had a 2.50 ERA”) the programmer may simply add the concept storycom “doesn't need indefinite article” to the inheritance basket of the “countable” concept storycom. Since all stats with the “countable” storycom inherit everything in the “countable” storycom inheritance basket, each of those stats now has the attribute of not needing an indefinite article.

The other list that each storycom includes is a pendant list. These are attributes that are not inherent to the storycom, and can therefore change depending on how the storycom is being used. For instance, there can be a storywriter storycom for “team did well in a certain statistical category.” If the category was “RBI,” a programmer can add an “RBI” storycom to the storywriter storycom's pendant list, signifying that “RBI” is the category that the storywriter storycom is dealing with. These pendants are specific to each storycom and are not inherited like those in the inheritance basket.

Each storycom has its own dedicated writer function. For instance, the word storycom “move” has a writer function that conjugates the verb “move” for every possible tense and sentence construction. Storywriter storycoms include writer functions that include the logic required to write entire stories. These writer functions work the same as those used by story writers, phrase writers, and word writers. The advantage comes from the fact that the writer function is embedded in the storycom object, which allows it to fit into conceptual hierarchies. Storycoms can also include intelligence functions, which are described in more detail below.

Storycom objects carry basic values that help identify what they are. Each storycom includes a unique ID number. They also can include “owners,” which signify that the storycom relates to a certain entity (like a player or team). Finally, storycoms include interest values, which work just like the interest values in the story matrix described above.

Word storycoms can be strung together to create a sentence by placing them into a sentence object. A sentence object includes a list of sentence parts, such as subject, object, preposition, punctuation, verb, auxiliary verb, etc. Each of these sentence parts, as necessary, is filled with one or more word storycoms. The sentence object also stores the order in which the sentence parts are to be arranged in the sentence part order list. In addition, the sentence object includes the tense of the given sentence.

As an example, a programmer may arrange word storycoms in a sentence object in the following way:
<subject>Team X (Word storycom 801)
<verb>Do (Word storycom 801)
<object>Good (Word storycom 801)

To write “Team X did well,” the above sentence object needs to be in “past” tense. Once the sentence object is marked as being in past tense, the writer function for the verb “do” recognizes that, and write the appropriate word “did.” In addition, the “good” word storycom can recognize that if it is in the “object” sentence part of a sentence object, it should change its text output to “well.”

Sentence objects also include a pendant list that stores a list of concept storycoms that apply to the sentence object. These concepts include things such as whether the adverb in the sentence object is necessary or whether the subject can be replaced by a pronoun. These attributes can be used by other functions in the program that need to interact or merge with the information contained in the sentence object, such as sentence combiners (described in detail below).

Sentence objects do not need to be full sentences, but instead may be merely a sentence fragment. Sentence objects may also include other sentence objects as one of their sentence parts. These sentence objects can work as relative clauses for their parent sentence object.

Breaking the sentence into its component parts allows future parts of the narrative to draw additional information from the sentence. For instance, whether a team name should be replaced with a pronoun might depend not only on whether the team name was mentioned in the previous sentence, but on whether it was the object or subject of that sentence.

In addition, using sentence objects allows sentences to be written with word storycoms, which then output different text based on the intelligence contained within the word storycom writer function. In other words, there does not need to be different text options for each tense, but instead one version that automatically adapts when the tense, or other elements, changes (examples of such changes are described below).

Finally, and most importantly, breaking the sentence into component parts allows functions to mix and match sentence objects together, in a process described in more detail below.

Intelligence storycoms include functions that analyze narrative situations and suggest narrative changes. Storywriter storycoms often have intelligence storycoms in their inheritance basket. At the beginning of a storywriter storycom's writer function, the writer function checks all the storycoms in its storycom object's inheritance basket to see if any of them include intelligence functions with narrative suggestions. In pseudo code, it looks like this:
Function writeStoryX( ) (this is the writer function attached to storycom StoryX)
   1. Look through my inheritance basket to see if there are any storycoms with intelligence functions
   2. If so, return information from those functions
   3. Alter my writing to incorporate the information returned by the intelligence functions (maybe call a sentence combiner 1050 to help with this process)
End function

A simple example of intelligence storycoms occurs when two player stories are written back-to-back, where both stories concern a player doing badly. Each of these stories include an intelligence storycom in their inheritance basket that deals with back-to-back player stories. When the first story is written, that intelligence storycom has no effect as long as the previous story was not also about that player. However, when the second story about the player is written, the intelligence storycom suggests changing the text output of the player story's storywriter function. The narrative suggestions take the form of sentence objects that are passed from the intelligence storycom to the storywriter storycom. For instance, in the above example of a second negative player story, the intelligence storycom may return a sentence object that contains the adverb “also.” If it does, the storywriter function that called that intelligence storycom incorporates the new sentence object using a sentence combiner, as described in more detail below.

Intelligence storycoms are beneficial because they allow a programmer to easily create narrative flow between stories. Intelligence storycoms can “centralize” things like transitions that exist at the beginning of a storywriter. Instead of each storywriter having its own separate logic that looks to the previous parts of the narrative (checking semantic values), all similar storywriters can share the transition logic. By centralizing the code, it makes it easier to make changes and add variety. More importantly, the transitions for multiple stories of the same type can all be held in one option list (described in detail below), which reduces the likelihood of repetition.

The narrative generator uses option lists to provide a variety of story writing options. For instance, instead of just including one piece of text, storywriters may include an option list with many different suggestions. This is similar to text options described above, but option lists may be more dynamic and powerful. The narrative output of an option list can either take the form of raw text or sentence objects. In some embodiments, the option lists are used by all different types of writer functions and for the narrative suggestions from intelligence functions.

An option list may be made up of a list of phrase objects. Phrase objects are objects that include both a logic function and writer function. When a phrase object's logic function is called, the function looks at the semantic values of other stories in the narrative to determine if it would be appropriate to call the phrase object's writer function. For instance, in the option list for the storyline function dealing with a player's good performance, there might be one phrase object that is only appropriate if the player did well in the batting average category. Accordingly, its logic function could check the storycom attached to the writer function to see if it includes a “batting average” storycom in its pendant list, signifying that it was about batting average performance. If so, it would return the value “true”, signifying that it would be appropriate to call the phrase object's writer function.

When a writer function is using an option list, it calls the logic function of every phrase object in the option list. It then stores the list of every phrase object that has been cleared by its logic function to be used. The writer function then typically selects the first phrase object in that list and calls the phrase object's writer function to get the text or sentence object that the phrase object's writer function returns. After being used, the phrase object goes to the back of the option list, so that the next time the option list is used, that phrase object will not be used unless every phrase object in front of it is not applicable (as determined by their logic functions). This helps make sure that the variety in the option list is maximized. All of the phrase objects that were identified as ok to be used, but not used, would get a “charge.” This is an integer value that stores the number of times a phrase object could have been used but wasn't. After a phrase object is used, this “charge” value is set to 0.

To maximize variety further, some phrase objects can be given a “minimum charge” property. A phrase object with a given minimum charge property cannot be used (even if it is at the top of the list) unless its “charge” value was at or above its minimum number of charges. A minimum charge may be beneficial when there are phrase objects targeted to specific situations that do not come up very often. Often, these phrase objects are unique and memorable. However, because they are not triggered very often, they will tend to move up towards the top of the list (since the more generic phrase objects will be getting used more often, meaning they will tend to be at the bottom of the list). By setting a minimum charge amount for these unique phrase objects, a programmer can make sure that readers will get the “generic” version a given number of times before the more memorable version is repeated again. This prevents readers from seeing the same thing every time a particular situation occurs. Programmers can also set the minimum charge property to an impossibly high number, to create “one off” phrase objects that will only be triggered one time and then never run again.

Sentence combiners are functions that take two or more sentence objects and combine them into one sentence object, using sentence parts from each sentence object. These sentence combiners allow intelligence storycoms and storywriter storycoms to work together. When a function, such as a storycom's intelligence function, creates a sentence object, it can add concept storycoms to the sentence object's pendant list. One of the concepts storycoms it can add, concerns what sentence combiner can be used to merge its sentence object with a sentence object from another function.

For instance, one sentence combiner deals with “subject and auxiliary verb” sentence objects. An example of this type of sentence object would say, for instance “The offensive explosion helped;” with “the offensive explosion” working as the subject and “helped” working as an auxiliary verb. This sentence object could be combined with a sentence object that said “Team X moved up in the standings this week”, to form the sentence “The offensive explosion helped Team X move up the in the standings this week.” The sentence combiner, in this case, would turn the subject of the second sentence object, “Team X”, into the object of the new combined sentence object, and change the verb “move” to its infinitive form.

The second sentence object (“Team X moved up in the standings this week”) would need to have the storycom that indicated it could be used with a “subject and auxiliary object” sentence combiner. Typically, a given storyline writer would be getting a list of possible sentence objects from its intelligence storycoms. This list of sentence objects would be checked against the sentence object the storyline writer wanted to write, to see which sentence objects had sentence combiners in common, and could therefore be joined together.

In one example, a narrative generator includes: a processor; a memory coupled to the processor, wherein the memory is configured to store program instructions executable by the processor; wherein in response to executing the program instructions, the processor is configured to: access a database storing a plurality of data elements; assign each data element an associated interest value and one or more semantic values; select one or more data elements based on interest values and semantic values; select one or more topic paragraph creators associated with selected elements, wherein each paragraph creator acts on data elements with complimentary semantic values; enact a filter level that excludes data elements from use in the one or more topic paragraph creators based on interest vales; implement a plurality of writers to create a plurality of narrative blocks related to the selected topic paragraph creators, each writer including a plurality of text options from which a narrative block is constructed, wherein text options are selected for inclusion in a given narrative bock are based at least in part on reference to a narrative companion array and a grammar companion array, wherein the narrative companion array includes semantic values corresponding to the data elements included in any of the plurality of narrative blocks, wherein the grammar companion array includes grammar values associated with the text options included in the plurality of narrative blocks.

The plurality of writers may include fixed text options, variable text options, and calls to additional writers. The processor may be further configured to identify a data element to be associated with a headline. The processor may consider the interest value of the data elements as well as previously used headlines in identifying the data element to be associated with the headline. The processor may be further configured to identify a headline from a plurality of potential headlines, wherein the identified headline includes at least one common semantic value corresponding to a semantic value associated with the identified data element. The processor may be further configured to identify a visual media element including meta-data corresponding to a semantic value associated with the identified data element. The processor may be further configured to identify a global theme by identifying recurring semantic values in the stored data elements. The processor may be further configured to provide a custom writer through which a user may provide one or more custom data elements for inclusion in the database. The processor may be further configured to provide a sidebar writer adapted to provide a visual representation of one or more of the data elements. The processor may be further configured to identify a data element for which additional user input is desired, present a question to a user through an output mechanism, receive a corresponding user input through an input mechanism, and incorporate the user input into a narrative block.

Each of the plurality of writers may be a story communicator, wherein each story communicator includes: an associated interest value; an inheritance basket of properties applicable to the specific story communicator and further applies to any other story communicator that references the specific story communicator; a pendent list of properties applicable to the specific story communicator that do not apply to any other story communicator that references the specific story communicator; and a writer function that conjugates any verb included in the story communicator. The processor may be further configured to provide a plurality of sentence objects, each sentence object including a plurality of sentence parts, wherein the sentence parts call corresponding story communicators based, at least in part, on the associated interest value.

Each writer may select text options for inclusion in the corresponding narrative block without reference to another writer. Each text option may be associated with a charge expressed an integer value that counts the number of times the text option could have been used, but was not. One or more of the text options may have a minimum charge required in order to be selected.

In another example a narrative generator includes: a processor; a memory coupled to the processor, wherein the memory is configured to store program instructions executable by the processor; wherein in response to executing the program instructions, the processor is configured to: provide a plurality of story communicators, wherein each story communicator includes: an associated interest value; an inheritance basket of properties applicable to the specific story communicator and further applies to any other story communicator that references the specific story communicator; a pendent list of properties applicable to the specific story communicator that do not apply to any other story communicator that references the specific story communicator; and a writer function that conjugates any verb included in the story communicator; and provide a plurality of sentence objects, each sentence object including a plurality of sentence parts, wherein the sentence parts call corresponding story communicators based, at least in part, on the associated interest value.

The processor may be further configured to create a plurality of narrative blocks, each formed from a plurality of sentence objects. The inheritance basket of a first story communicator may includes a second story communicator.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic block diagram that illustrates stages of a narrative generator, according to an embodiment of the solutions presented herein.

FIG. 2 is a schematic block diagram that illustrates a story matrix, according to the embodiment shown in FIG. 1.

FIG. 3 is a schematic block diagram that illustrates a topic paragraph creator, according to the embodiment shown in FIG. 1.

FIG. 4 is a schematic block diagram that illustrates a headline writer, according to the embodiment shown in FIG. 1.

FIG. 5 is a schematic block diagram that illustrates the creation of a custom element, according to the embodiment shown in FIG. 1.

FIG. 6 is a schematic block diagram that illustrates a narrative publishing system that makes repeated use of the narrative generator, according to the embodiment shown in FIG. 1.

FIG. 7 is a schematic block diagram that illustrates a narrative layout creator, according to the embodiment shown in FIG. 1.

FIG. 8 is a schematic block diagram that illustrates the narrative block and narrative block matrix, according to the embodiment shown in FIG. 1.

FIG. 9 is a schematic block diagram that illustrates an automated interviewer, according to the embodiment shown in FIG. 1.

FIG. 10 is an example of a narrative produced by an embodiment of the narrative generator.

FIG. 11 is a schematic block diagram that illustrates a story matrix creator, according to the embodiment shown in FIG. 1.

FIG. 12 is a schematic block diagram that illustrates a writer, according to the embodiment shown in FIG. 1.

FIG. 13 is a schematic block diagram that illustrates a context call system, according to the embodiment shown in FIG. 1.

FIG. 14 is a schematic block diagram that illustrates a theme matrix creator, according to the embodiment shown in FIG. 1.

FIG. 15 is a schematic block diagram that illustrates a semantic element array, according to the embodiment shown in FIG. 1.

FIG. 16 is a schematic block diagram that illustrates a storycom, according to another embodiment of the narrative generator.

FIG. 18 is a schematic block diagram that illustrates an option list and phrase object, according to the embodiment shown in FIG. 16.

FIG. 19 is a schematic block diagram that illustrates a sentence combiner, according to the embodiment shown in FIG. 16.

FIG. 20 is a schematic block diagram that illustrates a story seed, according to the embodiment shown in FIG. 16.

FIG. 21 is a schematic block diagram that illustrates hardware components of a narrative generator, as provided herein.

### DETAILED DESCRIPTION OF THE INVENTION

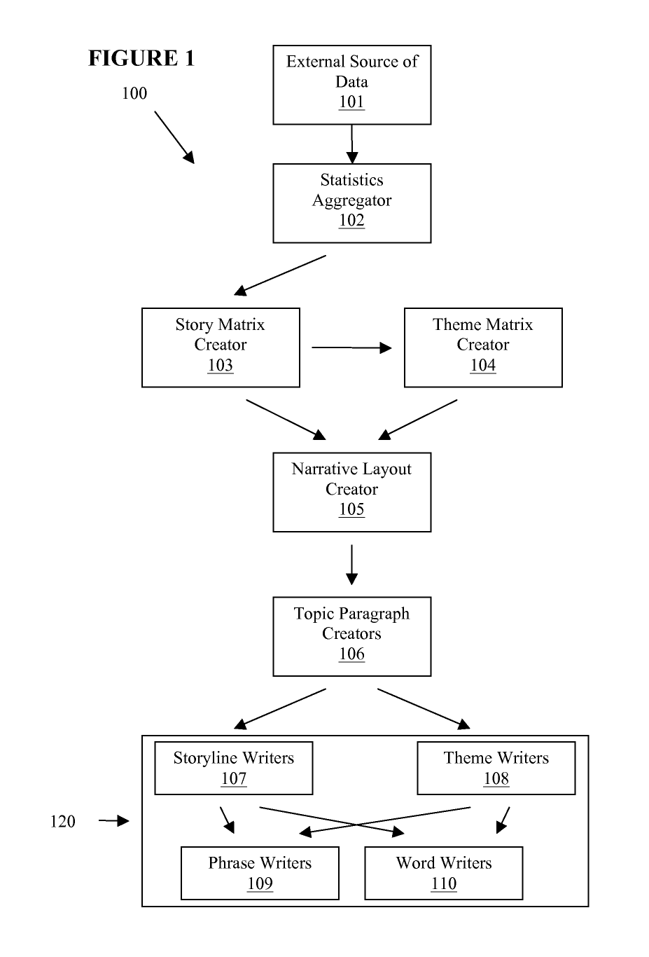

As shown in FIG. 1, the narrative generator 100 receives a data set comprising a plurality of data elements as input. The data set is sent to a statistics aggregator 102 that categorizes and stores each data element in the memory 70, wherein each data element is associated with at least one category tag.

In addition to categorizing and storing each data element, the statistics aggregator 102 may optionally create further data elements through an analysis of the data set. For example, a first data element and a second data element both included in the original data set may be compared to create a third data element that was not originally included in the data set. Any data elements created by the statistics aggregator 102 may further be stored in memory 70 and associated with at least one category tag. These additional data elements may be generated by a comparative analysis of original data elements, a combinatory analysis of the original data elements, a subtractive analysis of the original data elements, etc. Even further, additional data elements may be generated based on comparisons, combination, etc. involving other additional data elements.

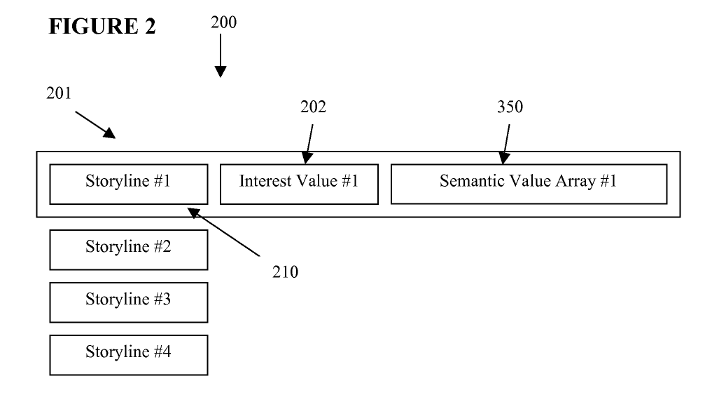

A story matrix creator 103 identifies a plurality of identified storylines 210 (shown in FIG. 2) from stored data elements. A storyline 210 is a narrative that describes one aspect of the data (e.g., “Team X plays a good opponent next week,” “Team Y had a comeback win this week,” “Coach A left the top performer on the bench last week,” etc.). The story matrix creator 103 identifies each storyline 210 by analyzing the data elements in light of a storyline sub-routine 220 associated with each potential storyline 210. For example, if Team X scored more points than Team Y, identify the storyline 210 “Team X won” and do not identify the storyline 210 “Team Y won.” The story matrix 200 generator 103 may include a story matrix 200 for each team, for each player, for each coach, etc.

As shown in FIG. 2, the story matrix creator 103 further assigns an interest value 202 to each identified storyline 210. The interest value 202 is a representation of how interesting the storyline 210 may be. For example, a fifty point win and a 65 point win may both trigger a “large blowout” storyline 210, but the 65 point win may be assigned a higher interest value 202. The interest value 202 is assigned by an interest value 202 function that is included in the story matrix 200 generator 103.

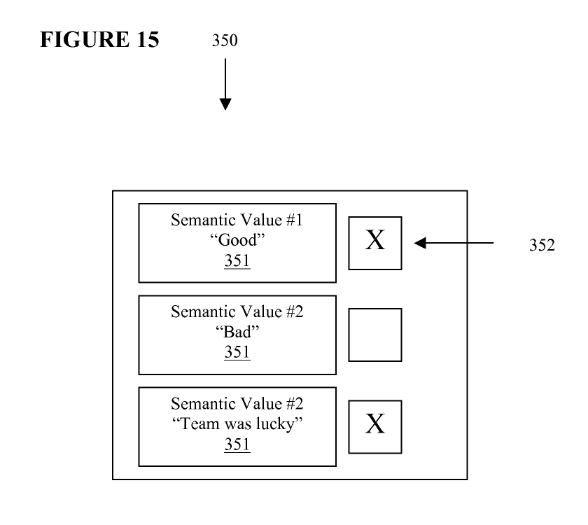

The story matrix creator 103 also assigns a semantic value 351 (FIG. 15) to each identified storyline 210. Semantic values 351 are both specific and generalized thematic values. For example, a semantic value 351 may be something specific, like “team got lucky,” or something generalized, like “good” or “bad.” Semantic values 351 are triggered by identified storylines 210. For example, the identified storyline 210 “Team X won” may trigger the assignment of the sematic values 351 of “good” and “team did well.” Sematic values 351 may be binary (i.e., on or off) or they may be qualitative (i.e., an assigned value as a percentage of a maximum value). In the example shown in FIG. 15, the semantic value array 350 includes a trigger indictor 352 that identifies when a specific semantic value 351 is triggered.

Returning to FIG. 1, once the story matrix creator 103 has identified the storylines 210 and assigned an interest value 202 and semantic value 203 to each, the theme matrix creator 104 identifies potential narrative themes. Just as the story matrix creator 103 identifies storylines 210 from the data elements, the theme matrix creator 104 identifies narrative themes from the identified storylines 210. The theme matrix creator 104 may also assign an interest value 202 and semantic value 351 to each identified narrative theme. In one example, if the identified storylines 210 include “Team X is on a losing streak” and “Team Y is on a losing streak” the theme matrix creator 104 may identify the narrative theme “both teams on losing streaks.”

The theme matrix creator 104 may be run numerous times throughout the process to further refine the use of narrative themes in the narration.

After the storylines 210 and narrative themes have been identified, the narrative generator 100 selects from amongst the identified storylines 210 and narrative themes and assembles them into a natural sounding narrative by calling sub-routines responsible for varying levels of the narration: narrative; topic; theme; storyline 210; phrase; and word. For example, the narrative generator 100 may include sub-routines including a narrative layout creator 105, a topic paragraph creator 106, a theme writer 108, a storyline writer 107, a phrase writer 109, and a word writer 110.

The narrative layout creator 105 performs the first level of the narrative assembly. The narrative layout creator 105 may identify headlines, media, and sidebars, as well as organize and order the conditions under which the topic paragraph creator 106 is called.

The narrative layout creator 105 identifies headlines, for example, by identifying the identified storyline 210 with the highest interest value 202. When there is a series of narratives, the narrative layout creator 105 may also take into consideration previously identified headlines so as to create diversity in the series of narratives.

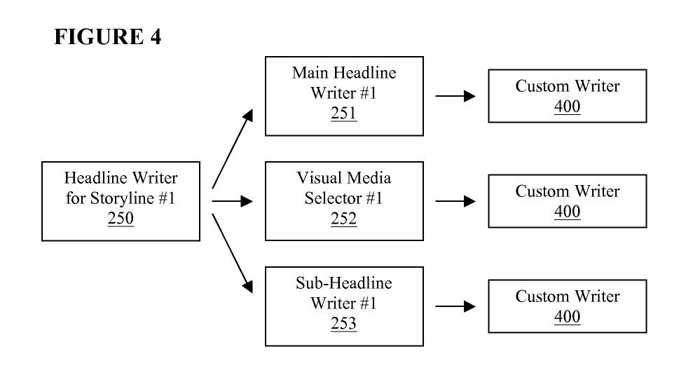

As shown in FIG. 4, the narrative layout creator 105 may include a headline writer 250 (FIG. 4), including a main headline writer 251 and a sub-headline writer 253. The main headline writer 251 may identify a main headline from a plurality of possible main headlines wherein the selected main headline has a relationship with the identified storyline 210 with the highest interest value 202. The sub-headline writer 253 may identify the sub-headline similar to the process described for the main headline writer 251. While main headlines may typically be short, witty statements, sub-headlines are typically more substantive.

As further shown in FIG. 4, the headline writer 250 may also include a visual media selector 252. The visual media selector 252 may identify one or more visual media elements corresponding to the headline(s). The visual media elements may be stored in association with meta-data that identifies the subject of the visual media, as well as contextual descriptors, such as positive, negative, etc. For example, if the identified main headline references a player in a positive light, the visual media selector 252 may select a visual media element with meta-data that identifies the referenced player in a positive light.

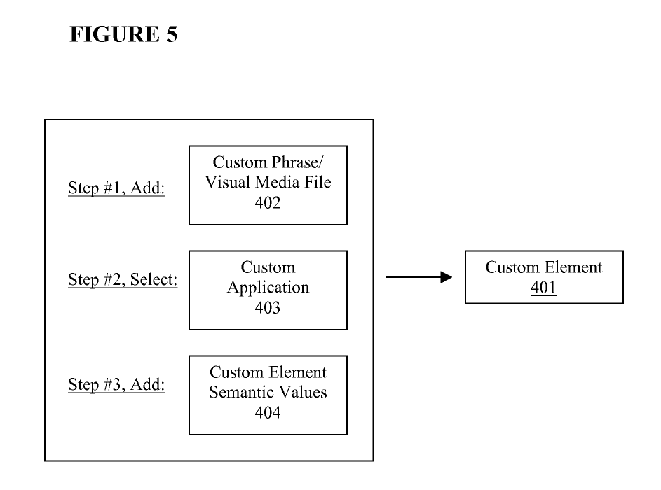

As shown in FIG. 5, custom elements 401 may be incorporated into the narrative generator 100 at varying levels of the narrative assembly. For example, custom writers 400 may be used to provide and select custom headlines and provide and select custom visual media. For example, custom elements 401 may be incorporated into the narrative assembly such as a custom headline written by a non-technical writer 120. The inclusion of custom elements 401 may increase the flexibility and responsiveness of the narrative generator 100.

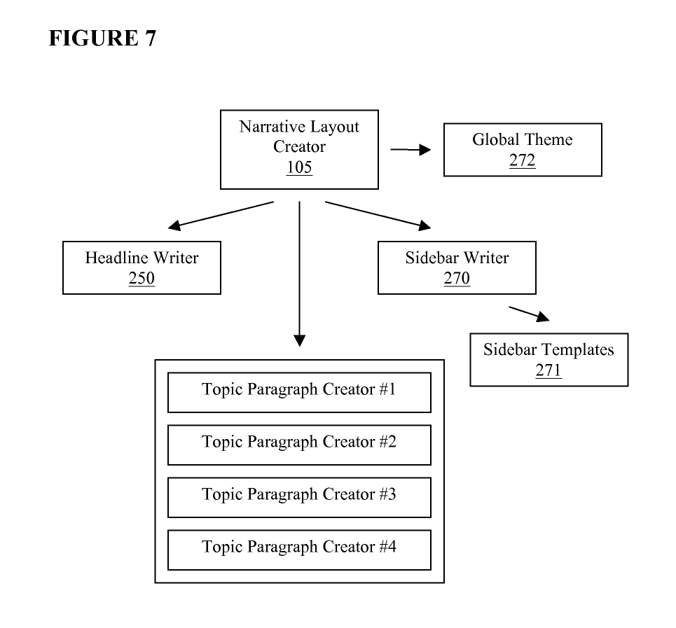

As shown in FIG. 7, the narrative layout creator 105 may also include a sidebar writer 270 that creates one or more sidebars as part of the narrative assembly. A sidebar is a visual representation of data that accompanies the verbal narrative. For example, the sidebar writer 270 may identify the identified storyline 210 referencing a statistics based data element with the highest interest value 202. The sidebar writer 270 may then call on a sidebar template 271 to express the data elements from the identified storyline 210 in a sidebar format.

The narrative layout creator 105 may further include a global theme selector 272. The global theme selector 272 may identify recurring themes in the semantic values 351 of the identified storylines 210 and select a global theme. For example, if many of the identified storylines 210 have a semantic value 351 of good luck, a global theme may be good luck. The other sub-routines may base one or more of their actions on the selected global theme or themes, as will be understood by those skilled in the art based on the disclosures provided herein.

After creating/identifying/selecting the headlines, sub-headlines, visual media, sidebars, and global theme(s), the narrative layout creator 105 selects the appropriate topic paragraph creators 106 and determines the order they are to be selected. The narrative layout creator 105 may choose different arrangements of topic paragraph creators 106 based on the types of headlines, the number of particular storylines 210 that have been identified, and the interest value 202 of those storylines 210, and other factors, such as a general need for variety in the format of narratives that are seen repeatedly. After choosing the order and type of topic paragraph creators 106 to be called, the narrative layout creator 105 calls each of the topic paragraph creators 106.

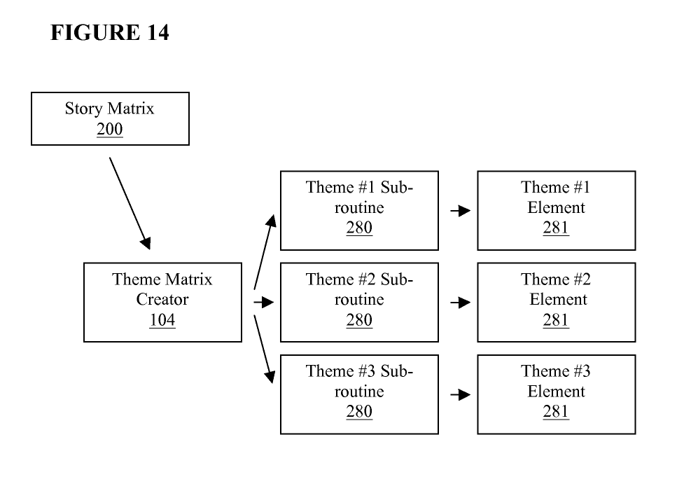

Topic paragraph creators 106 are sub-routines of the narrative generator 100 that assemble the portions of the narrative around a particular topic. Each topic paragraph creator 106 may create a paragraph, create more than one paragraph, or add to an existing paragraph. The topic paragraph creators 106 may further identify where paragraph breaks should occur, for example, based on the order and length of the identified storylines 210 and theme elements 281 (FIG. 14).

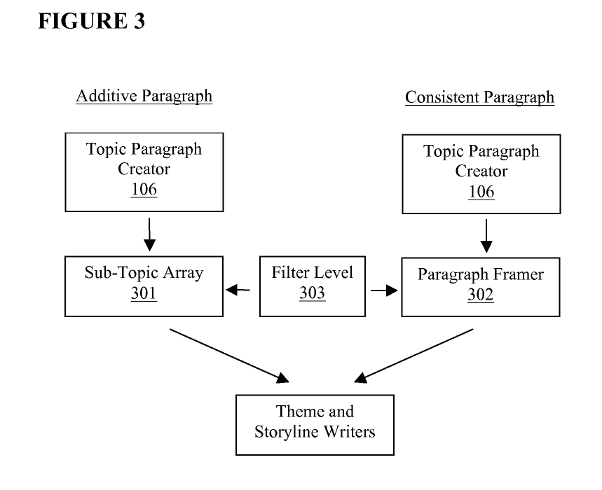

Turning to FIG. 3, topic paragraph creators 106 may create “additive” or “consistent” paragraphs. Additive paragraphs are those in which the number of relevant storylines 210 may be between zero and a large number. For example, a paragraph generated by a topic paragraph creator 106 concerning coaching mistakes may be an additive paragraph, because there may have been no coaching mistakes, or there may have been quite a few coaching mistakes. Consistent paragraphs are those based on storylines 210 that consistently occur in writing regarding certain subjects. For example, narratives concerning fantasy football may consistently include storylines 210 that describe which team won, how players did relative to their projected points. The topic paragraph creators 106 may work differently depending on whether they are assembling paragraphs that are additive or consistent in nature.

When creating “additive” paragraphs, a topic paragraph creator 106 may need to determine which additive storyline 210 to include in the narrative. One way of doing so is using the interest values 202 and semantic values 351 assigned to each storyline 210 by the story matrix creator 103. The topic paragraph creator 106 may include a sub-topic array 301 that triggers the inclusion of specific storylines 210. The sub-topic array 301 may include a plurality of storylines 210 in a plurality of sub-topic buckets. Each sub-topic bucket includes storylines 210 whose semantic value 351 matches the associated sub-topic. For example, one sub-topic bucket may include each of the storylines 210 that include a semantic value 351 of “playoffs.” Each of the sub-topic buckets may include a corresponding interest value 202. Accordingly, each storyline 210 may have an interest value 202 assigned by the story matrix creator 103 and another interest value 202 provided by the sub-topic array bucket with which it is associated.

For storylines 210 whose semantic value 351 is appropriate for the paragraph being created, the sub-topic array 301 may trigger storyline 210 inclusion based on the interest values 202 assigned to each storyline 210. The topic paragraph creator 106 may set a higher or lower cutoff for the minimum interest value 202 to determine whether to include a storyline 210 in the paragraph based on the number of storylines 210 that would be triggered in the sub-topic array 301. For example, if the paragraph length would be too long, the minimum interest value 202 for the cutoff may be raised. The topic paragraph creator 106 may look at each interest value 202 associated with each storyline 210 when making the determination of whether to include the storyline 210 in a given “additive” paragraph.

In a “consistent” paragraph, certain types of storylines 210 have the potential to appear every time, whether or not they are important for telling the narrative. For instance, when writing a paragraph about what happened during Sunday afternoon games between two fantasy football teams, one team will have scored more than the other, or they will have both scored the same amount. Every player who played will have scored more, the same, or less points, than was expected. However, some of these storylines 210 are more relevant to the overall narrative and it may be preferred to include only the most relevant storylines 210. For instance, one team may have outscored the other team during a particular time period, but that storyline 210 may not be important to the narrative if the game is already essentially over (by contrast, it would be of critical importance if the game was close and not complete). The main challenge of the topic paragraph creator 106 when assembling a “consistent” paragraph is to determine which of the consistently appearing storylines 210 are relevant to the narrative.

To deal with this problem, the topic paragraph creator 106 uses paragraph framers 302 to call appropriate storylines 210 into the paragraph. Paragraph framers 302 function essentially as mini-topic paragraph creators 106 that are more likely to call storylines 210 matching the paragraph framer's purpose. For example, if a matchup between two fantasy football teams is concluded, the topic paragraph creator 106 may call a paragraph framer 302 adapted to describing time periods where the outcome of the game is already determined. This paragraph framer 302 might then only call the storylines 210 related to “concluded” narratives.

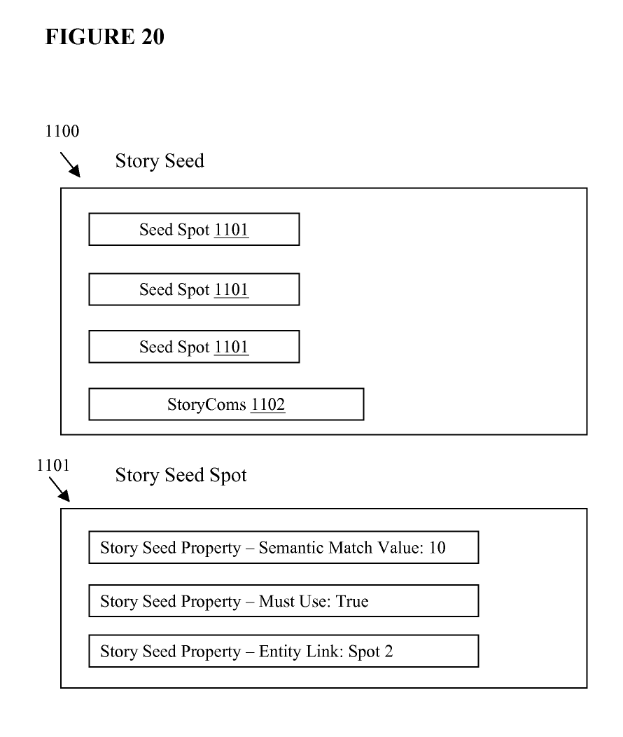

Additionally, paragraph framers 302 can be configured to write paragraphs with a given semantic value 351 (i.e., themes). These paragraph framers 302 are referred to as story seeds 1100 (FIG. 20). As shown in FIG. 20, story seeds 1100 include one or more seed spots 1101 that provide a semantic value 351 that may trigger the use of the story seed 1100. For example, a given story seed 1100 may include three seed spots 1101, each with a respective semantic value 351: “can be lead coach story;” “can be main coach story;” and “can be context coach story.” In addition, each seed spot 1101 may include properties that dictate seed spot usage. For example, a given seed spot 1101 may include the seed spot property “must be used,” which may indicate that if the story seed 1100 is triggered, it must be used in the narrative. Another property may be the story seeds 1100 relationship with other storylines 210, story seeds 1100, and seed spots 1101, etc. For example, if a first two seed spots 1101 that relate to a given player have been triggered, a third seed spot's properties may require that the third seed spot 1101 also refer to that given player.

The story seeds 1100 can call on storylines 210 whose semantic values 351 match that of the story seed 1100. In addition, story seeds 1100 themselves may include semantic values 351 such that the story seeds 1100 may be assembled into a group in a similar fashion to how storylines 210 are assembled by storylines 210.

The topic paragraph creator 106 may include a filter level 303 that is used to assemble paragraphs. The filter level 303 is a cutoff system that excludes storylines 210 whose interest level does not meet or exceed a threshold amount. The filter level 303 may start at a baseline level that is then subsequently adjusted as thematic narrative elements are put into place. For example, once a particular narrative element is set (e.g., the game is out of reach for the team trailing), the filter level 303 may adjust to exclude storylines 210 that may no longer be as relevant.

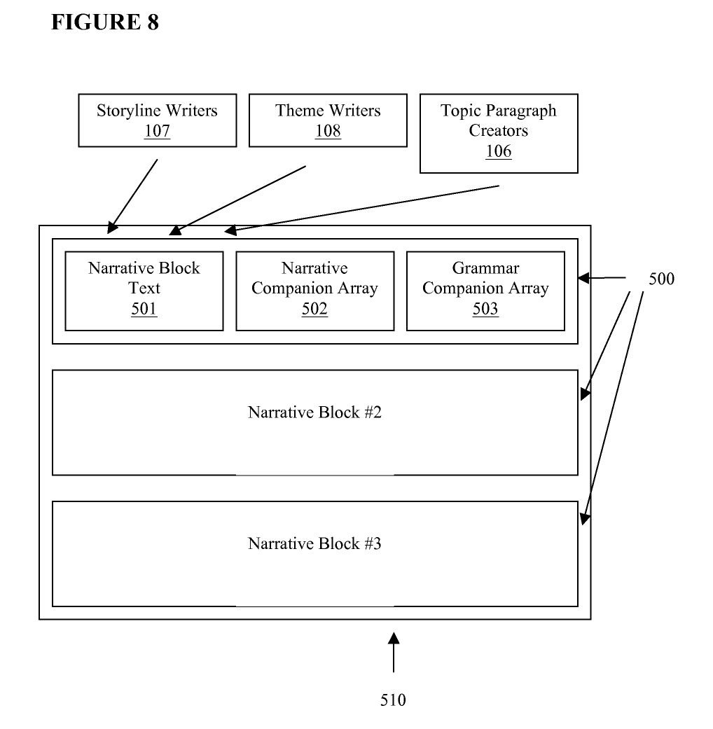

After the topic paragraph creator 106 selects the storylines 210 for inclusion in the paragraphs and chooses the paragraph themes, the topic paragraph creator 106 calls upon theme writers 108 and storyline writers 107 to write the words for the narrative. The theme writers 108 and storyline writers 107 may call on phrase writers 109 and word writers 110 to assist in the process. The theme writers 108, storyline writers 107, phrase writers 109, and word writers 110, collectively the writers 120, compose narrative blocks 500 as shown in FIG. 8. Narrative blocks 500 are at least one sentence long, but may be more than one sentence. Narrative blocks 500 include narrative block text 501, punctuation, and formatting that will be published as the narrative output 151. The narrative blocks 500 are stored in a narrative bock array 510.

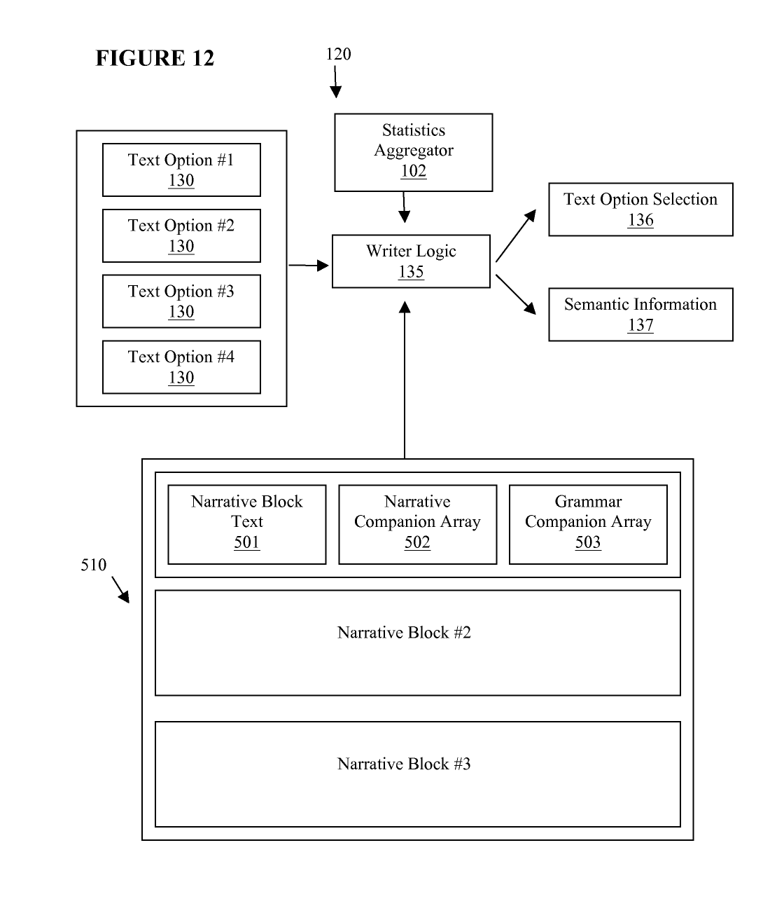

As shown in FIG. 12, the writers 120 are a series of text options 130, wherein one option is selected by the writer logic 135 to meet the needs of the narrative. The text options 130 may be fixed text (e.g., “The game was over by Monday night”), may be text including variables (e.g., [Team X] did well Sunday afternoon.”), or may call on lower level writers 120 (e.g., [Team X] & phraseTeamPerformance & phraseWhatTime.”). In some embodiments of the narrative generator 100, each option in a writer 120 includes the same basic narrative information, but is phrased differently to enable the writer 120 to select the construction that fits the context of the narrative best.

To determine the best text option 130 to select, the writer logic 135 analyzes information included in other narrative blocks 500 and information from the statistics aggregator 102. For example, a storyline writer 107 relating to the storyline 210 “team's upcoming opponent is on a losing streak” might include a first text option 130 that states, “[Team A] should have an easy time next week as [Team B] will come into the game on a [X] game losing streak.” However, the writer logic 135 for that storyline writer 107 may check to see if a previous narrative block 500 already mentioned the upcoming team being a weak opponent (as described further herein). If such a statement had previously been made, the writer logic 135 could select a different text option 130, one more appropriate for the narrative as a whole. For example, the more appropriate text option 130 may state, “In addition, [Team B] will come into the game on a [X] game losing streak.”

After the writer logic 135 identifies the appropriate text option 130 and adds it to the narrative block 500, the writer logic 135 adds the appropriate semantic information 137 to a narrative companion array 502 and a grammar companion array 503. These arrays are examples of semantic value 351 arrays 203 that enable the writers 120 to select more appropriate text options 130 to improve the overall cohesiveness of the narrative.

As further shown in FIG. 12, the narrative companion array 502 stores semantic elements that correspond to each narrative block 500. For example, these semantic elements may include “mentions other team,” “mentions team got lucky,” “this narrative block 500 is a theme,” etc. These semantic elements are triggered, or activated, by the writers 120 when text options 130 are selected. Each text option 130 available in a given writer 120 may trigger identical semantic elements, overlapping, but non-identical semantic elements, or mutually exclusive semantic elements.

Narrative companion arrays 502 are critical to allow each writer 120 to operate independently while creating content that is coherent in the context of the greater narrative. Although the list of possible semantic elements may be very long, each individual writer 120 only needs to check the narrative companion array 502 for those semantic elements that are relevant to the writer 120's content. For instance, a storyline writer 107 that deals with a team having injury concerns might include a text option 130 that reads, “Coach X was dealing with injury issues.” However, before selecting this text option 130, the writer logic 135 for the storyline writer 107 may look at the narrative companion array 502 to determine whether a previous narrative block 500 relating to the other team had triggered the semantic element “team dealing with injuries.” If so, the writer logic 135 could select an alternative text option 130 that reads, “Coach X was also dealing with injury issues.” However, each writer 120 would not need to have separate text options 130 corresponding to every combination of semantic elements in the narrative companion array 502 because most of those semantic elements would have no effect on the optimal content for the writer 120 to produce.

The grammar companion array 503 stores various grammar values relating to the grammatical content of the words and phrases used in the narrative. The grammar companion array 503 enables the various writers 120 to choose coherent text options 130. For example, if the phrase “even better” is used in an existing narrative block 500, the semantic element corresponding to the phrase “even better” is triggered in the grammar companion array 503 associated with that narrative block 500.

Each of the writers 120 can access the grammar companion arrays 503 to identify aspects of previous narrative blocks 500 that conflict with what the writer 120 may select. Each writer 120 only needs to check those elements that would potentially conflict with what the writer 120 intends to write. For instance, a writer 120 that is using the phrase “even better” would check to see if the previous narrative block 500 uses that phrase by checking the corresponding grammar companion array 503. If the previous narrative block 500 includes the phrase “even better,” the writer 120 then selects a text option 130 that does not include the phrase “even better.”

The grammar companion array 503 can also be used to identify the form and tense of a particular narrative block 500. This is useful for when a particular narrative block 500 is being constructed by multiple different writers 120, each of which is independent from each other. Without adding intelligence to the narrative generator 100 through the use of the grammar companion array 503, the resulting narrative block 500 could end up jumbled. For instance, certain terms, such as “meanwhile” indicate that the rest of the sentence is in the “past progressive” form and tense.

Accordingly, a storyline writer 107 may begin construction of narrative block 500 by using a phrase writer 109 that identifies that the action described by the current narrative block 500 took place at the same time as the previous narrative block 500. Accordingly, this phrase writer 109 may start the narrative block 500 with the phrase “Meanwhile,” and mark the semantic element in the grammar companion array 503 that identifies this narrative block 500 as being in the “past progressive” tense. The storyline writer 107 would then pass the generation of rest of the narrative block 500 to other phrase writers 109 and word writers 110. Despite not having any direct connection to the phrase writer 109 that wrote “Meanwhile,” the other writers 120 could use the information contained in the grammar companion array 503 to understand the proper form and tense of the narrative block 500 and write their individual portions using appropriate grammar by selecting text options 130 available to them that are in the proper tense and form.

In some embodiments, after selecting which storylines 210 and theme elements 281 to use, and identifying the order they will be called, the topic paragraph creator 106 calls the theme writer 108 associated with the theme elements 281 (FIG. 14) the topic paragraph creator 106 has selected. Theme writers 108 are used to place storylines 210 into the appropriate context. Theme writers 108 can set the scene for an entire paragraph, or simply tie two storylines 210 together. An example of a theme is that both coaches in a fantasy sports match-up have storylines 210 that involved poor decisions. The theme writer 108 might then create a narrative block 500 with narrative block text 501 that reads: “Both coaches made bad decisions this week.”

In some embodiments, after writing the narrative block 500 to the narrative block array 510, the theme writer 108 triggers any appropriate semantic information 137 in the narrative companion array 502 and grammar companion array 503.

Returning to FIG. 8, as described above, when writing individual storylines 210, the narrative generator 100 uses a storyline writer 107. Each storyline 210 in the story matrix 200 has its own dedicated storyline writer 107 that writes a narrative block 500 appropriate for the particular storyline 210. For instance, in one embodiment, a specific storyline 210 is triggered when a team does not have any players in the top 20 for fantasy points for the year. The storyline writer 107 associated with this storyline 210 might select a text option 130 that states: “[Team X] currently has no players in the top twenty in total points.” These words might constitute the entire narrative block 500, in which case the storyline writer 107 would add the text to the narrative block 500.

Storyline writers 107 can be simple or complex. Certain storylines 210, when written out by a storyline writer 107, include similar words regardless of the context in which the storyline 210 is written. For these storylines 210, the storyline writer 107 writes the words of the narrative block 500, as in the example given above. Other storylines 210 will be so dependent on context that the storyline writer 107 essentially only sets up the structure of the narrative block 500 and relies on phrase writers 109 and word writers 110 to generate the actual content. For instance, a storyline writer 107 for a storyline 210 that is describing how a team performed during a particular time period might include a text option 130 that looks like this: “phraseMeanwhile( ) & phraseWhatTimePeriod( ) & phraseTeamPerformance( )”.

After the storyline writer 107 generates the appropriate text (either directly or by receiving text from phrase writers 109 and word writers 110), the storyline writer 107 adds the text as the narrative block text 501 in the narrative block 500 that it is working on and the storyline writer 107 triggers the appropriate semantic elements in the associated narrative companion array 502 and grammar companion array 503.

Theme writers 108 and storyline writers 107 use phrase writers 109 to write the sub-parts of a narrative block 500 that are subject to a significant amount of variation. Phrase writers 500 return a text option 130 selection and appropriate semantic information 137 that is then incorporated into a narrative block 500 by theme writers 108 or storyline writers 107. Typically, the phrase writer 109 is used to create only part of a sentence, but in some instances the phrase writer 109 can be used to create a whole sentence, particularly when the sentence is part of a multiple sentence narrative block 500.

As an example, a phrase writer 109 can help put together the narrative block 500 corresponding to the storyline 210 that states that a fantasy sports team has done well during a particular time period. That team might have done well because one player had a good game, two players had a good game, one player had a great game that offset another player's bad game, etc. Since these various kinds of performances might only be one part of the narrative block 500, the storyline writer 107 may call a phrase writer 109 to generate the appropriate phrase relating to the player performance that led to the good result. The code corresponding to the text option 130 for the storyline writer 107 may look something like this:

Text Option 130 #1=“[Team A] had a great performance in the afternoon,” & phrasePerformanceExplanation(afternoon, team A)

When the phrase writer 109 “phrasePerformanceExplanation” is called, the writer logic 135 for the phrase writer 109 sorts through the data generated by the statistics aggregator 102 and determines which text option 130, out of a list of text options 130, most accurately describes the data. In this embodiment, the text options 130 would all be similar types of narratives, but would potentially be inconsistent with each other.

In other embodiments, all of the text options 130 of a phrase writer 109 may be consistent with each other. In such an example, the phrase writer 109 is used to select the most appropriate phrase from a series of synonymous phrases in order to improve the narrative quality. For instance, the phrase writer 109 uses the grammar companion array 503 to determine if a similar phrase has been used recently in the narrative and selects a text option 130 that does not use the same words included in the previous phrase.

Phrase writers 109 including inconsistent text options 130 and phrase writers 109 including synonymous text options 130 are not mutually exclusive. In some embodiments, one phrase writer 109 uses its writer logic 135 to determine which text option 130 best fit the data from the statistics aggregator 102, and then the selected text option 130 includes a call to another phrase writer 109 that includes a series of synonymous phrases as text options 130, and the phrase writer 109 determines which of the synonymous text options 130 to select.

Word writers 110 are used to write words in ways that are grammatically accurate and contribute to narrative flow. Word writers 110 are called by writers 120 higher up in the hierarchy of the narrative generator 100 (i.e., theme writers 108, storyline writers 107, and phrase writers 109) to select a text option 130 and trigger appropriate semantic information 137 in associated narrative companion arrays 502 and grammar companion arrays 503. Word writers 110 are specific to a word or a pair of words. For instance, a phrase writer 109 may use the phrase “was having a great afternoon” to describe a good performance. However, the beginning of the narrative block 500 may be organized in such a way that the use of the verb “was having,” which is in the past progressive tense, is inappropriate. A word writer 110 for the verb “have” can be called up to identify the proper form and tense of the narrative block 500 and insert the appropriate verb tense and form.

In some embodiments, the word writer 110 can be used for adjectives. The word writer 110 can change the adjective based on concerns such as the recent use of the same adjective in other narrative blocks 500, or selecting different adjectives that have not been overused in other narratives that are part of a series, such as the yearlong reporting of a fantasy sports league. For instance, if a phrase writer 109 contains the phrase “was doing terrible,” the word “terrible” can be written by a word writer 110, which would select from a bank of text options 130 that are synonymous with the word “terrible.”

Like the headline writer 250 described above, all writers 120 can take advantage of custom writers 400 shown in FIG. 4. Writers 120 can check to see if there are custom elements 401 to be incorporated into the narrative block text 501. For instance, a storyline writer 107 that talks about a player's good performance could check to see if there is a custom element 401 involving that player that would be relevant to their performance, such as the fact that the player was injured. The storyline writer 107 may include a text option 130 written to incorporate a custom phrase involving injury, and the writer logic 135 may select this text option 130 and incorporate the custom phrase. The text option 130 code may look like this:

Text Option 130 #1: “[Player X] shook off his” & customInjuryWriter 120(Player X) & “and dropped [Y] points.”

This text option 130 may produce a narrative block text 501 that reads: “Player X shook off his sore ankle and dropped 30 points.”

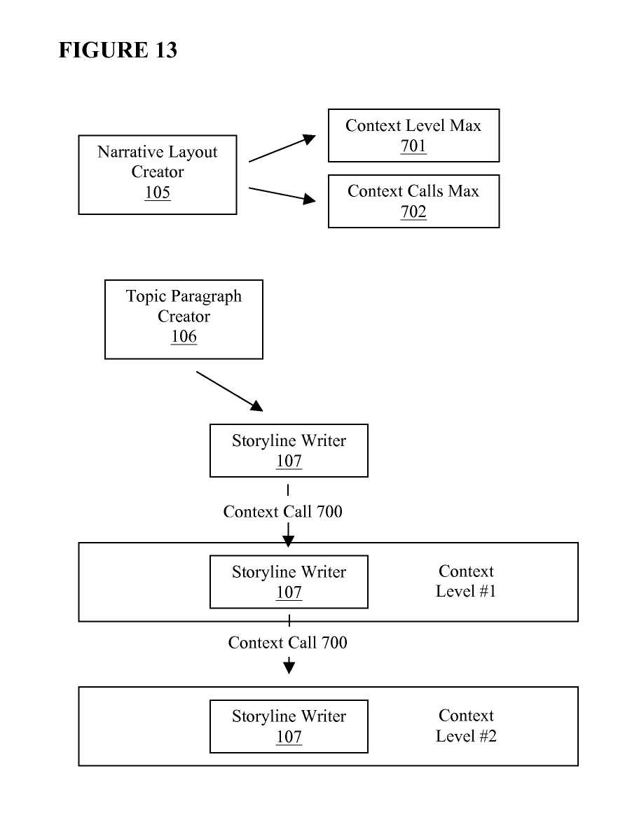

The examples provided above describe a top down structure of storyline 210 identification and assembly, wherein topic paragraph creators 106 call storyline writers 107. Building on these examples, as shown in FIG. 13, each individual storyline writer 107 may use context calls 700 to generate additional appropriate narrative blocks 500. A context call 700 occurs when a storyline writer 107 calls another storyline writer 107 directly. For instance, a storyline writer 107 that writes a narrative block 500 relating to “player X over performed and won the game” may check to see if the storyline 210 element for “player X is on a streak of over performance” is triggered in the player story matrix 200. If it is, the storyline writer 107 for “player X is on a streak of over-performance” can be called directly from the storyline writer 107 for “player X over performed and won the game.” If one storyline writer 107 calls another storyline writer 107 with a context call 700, that is a “Level 1” context call 700. If that storyline writer 107 then calls another storyline writer 107 with a context call 700, that is a “Level 2” context call 700 and so on. The context level is reset to 0 once the topic paragraph creator 106 calls a storyline writer 107 directly.

To keep this system from running wild and potentially creating a narrative with too much detail and context, as shown in FIG. 15, the narrative layout creator 105 can place a cap on the number of context calls 700 by setting a context calls max 702 and also setting a context levels max 701. The context calls max 702 is a variable that sets a limit on the absolute number of context calls 700 that are allowed to occur in the narrative. The context level max 701 is a variable that sets a limit on the maximum context levels that are allowed. The context calls max 702 and the context levels max 701 can be set either on a global basis, applying to the entire narrative, or can be set to only apply to particular topic paragraph creators 106.

The narrative generator 100 may be adapted to dynamically change the average length of the narratives it creates through any one or more of the following various methods. First, the narrative layout creator 105 can call a greater or lesser numbers of topic paragraph creators 106. Second, for additive paragraphs, the topic paragraph creators 106 can reduce or expand the number of different sub-topics allowed to be discussed in the paragraph. Third, for consistent paragraphs, the topic paragraph creators 106 can start with a lower or higher filter level 303 value, allowing different amounts of content to be deemed important for the narrative. Fourth, the article layout creator can limit or expand the levels and number of context calls 700.

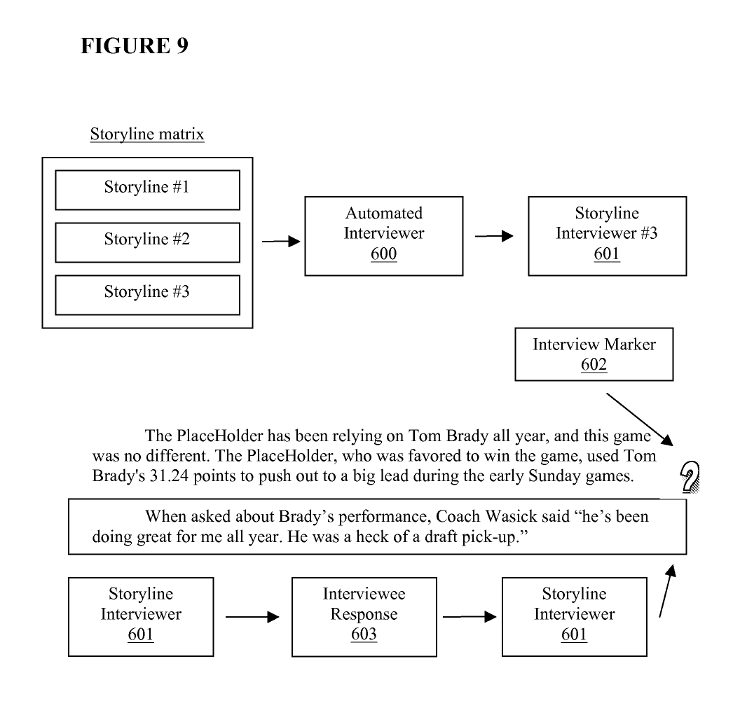

Turning to FIG. 9, the narrative generator 100 can also integrate open-ended information from human sources after the narrative has been written. It does this by using the automated interviewer 600. The automated interviewer 600 identifies certain storylines 210 for which acquiring additional information about those storylines 210 from human readers may benefit the narrative. The automated interviewer 600 can be adapted to use the interest values 202 of the storylines 210 to determine which storylines 210 to pose questions about. Alternatively, in some embodiments, the automated interviewer 600 may determine which storylines 210 to pose questions about by looking for particular semantic elements in each storyline 210 element's semantic value array 350.

In one embodiment, each storyline 210 element includes a dedicated storyline interviewer 601 that includes a question, or multiple questions, related to the storyline 210. For instance, if there is a storyline 210 that concerns a player doing well, the storyline interviewer 601 dedicated to that storyline 210 may include the question: “What do you think about player X's performance?” In addition to the question that is posed to the interviewee, the storyline interviewer 601 may include a phrase that is a summary of the question posed. For example, the summary phrase for the question “What do you think about player X's performance” could be: “When asked about player X's performance, Coach A said.” This phrase will be incorporated with the interviewee response 603 to create a new narrative block 500 to be inserted after the narrative block 500 that includes the storyline 210 element identified by the automated interviewer 600. In some embodiments, when adding the new narrative block 500, the storyline interviewer 601 makes grammar changes such as making sure there is a period at the end of the interviewee response 603, or changing the capitalization of the first letter of the interviewee response 603. In some embodiments, the interviewee will be able to select from a list of semantic values 351 that can be attached to his/her interviewee response 603.

In some embodiments, when a reader is viewing the narrative, an interview marker 602 appears next to the part of the narrative where the automated interviewer 600 has identified a narrative block 500 that includes a storyline 210 element that is ripe for an interview question. In some embodiments, the interview marker 602 only appears to certain readers. For instance, in the fantasy football example, the interview marker 602 may only appear if the coach to be interviewed is the one viewing the narrative.

As an example, in one embodiment shown in FIG. 9, if a fantasy team owner is reading an article about his own team, the automated interviewer 600 places an interview marker 602 next to the storyline 210 element for which it wants additional information. When the fantasy owner clicks on the marker, the storyline interviewer 601 asks a question that is relevant to that storyline 210 element. For instance, if the storyline 210 element concerns a particular player on an underperforming streak, the question from the storyline interviewer 601 might read: “Coach X, player A underperformed yet again in this week's contest, what do you think about that?” The response from the coach is recorded as the interviewee response 603. The storyline interviewer 601 then combines this response with the phrase that summarizes the question posed (e.g., “When asked about player A's continuing underperformance, Coach X said”) and add this text as the narrative block text 501 for a new narrative block 500. This narrative block 500 is then added to the narrative block array 510 in the position immediately following the narrative block 500 identified by the automated interviewer 600 identified. All of the other narrative blocks 500 in the narrative block array 510 are pushed down one space and the narrative is ready for republishing.

In some embodiments, after all of the topic paragraph creators 106 have been called by the narrative layout creator 105, all of the narrative blocks 500 stored in the narrative block array 510 are published as the narrative output 151. The narrative output 151 represents the final presentation of the text and visual information created by the narrative generator 100.

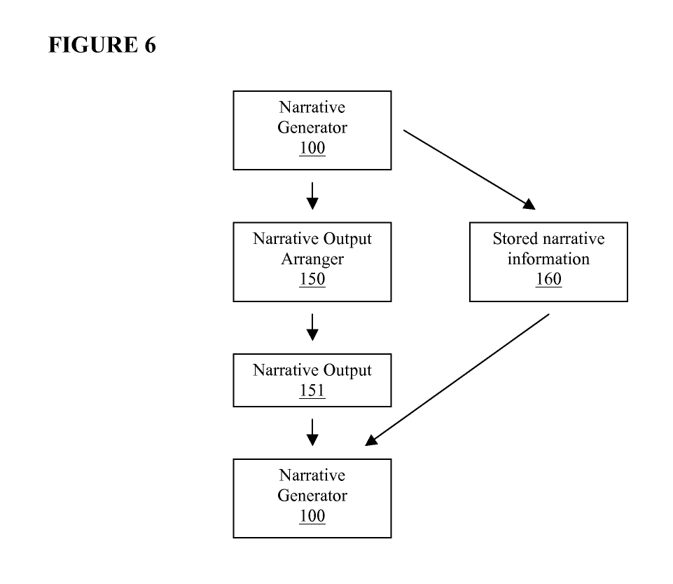

In some embodiments, as shown in FIG. 6, a narrative output 151 arranger 150 acts on the finished narrative block array 510, along with any headlines, pictures, and sidebars, to arrange the narrative and visual information generated by the narrative generator 100 into a form that is more pleasing to the reader. For instance, the narrative arranger could make sure the headlines appear before the body of the narrative, and that sidebars appear next to the storyline 210 element that they were derived from.

In some embodiments, the narrative output arranger 150 selects one “top headline” out of several headlines that were generated by the narrative generator 100 for each of several narratives. This “top headline” may be selected for having the highest interest value 202 or for other factors, depending on the requirements of narrative presentation. In this embodiment, the narrative output arranger 150 might show the top headline, along with the visual media file 402 associated with it, for only one narrative, and show the sub-headlines for all the other narratives. This type of presentation mirrors the presentation format currently used on many news websites.

In some embodiments, information created by the narrative generator 100 (such as narrative blocks 500 and data from the statistics aggregator 102) can be stored as stored narrative information 160, so that the information contained therein can influence a subsequent narrative created by the narrative generator 100. This may help narratives that are generated in a series to avoid undue repetition, such as avoiding the selection of a headline that is exactly the same as a headline generated in the previous narrative.

Furthermore, the stored narrative information 160 may be adapted to allow the narrative generator 100 to act as an external data for a narrative generator 100 that is creating a different type of narrative. For instance, in a fantasy sports league, one narrative generator 100 could be used to generate articles on what happened in each week's fantasy sports match-ups. A different narrative generator 100 could be used to write articles about the league itself, and how it compares to other leagues for which the narrative generator 100 is writing articles. It could do this by accessing the stored narrative information 160 left by the “match-up” narrative generator 100 and using that information as its external data source 101. Such an article might point out that “good coaching” stories were written up more often in this particular league than they were in the average league.

In the above-described embodiment, the various elements, such as theme writers 108, story writers 120, phrase writers 109, word writers 110, and semantic tags, are all described as separate function types. The semantic elements, for instance, are stored in array, and can be set as on or off. An alternative embodiment takes all writing functions and semantic elements and turns them into storycoms 801.

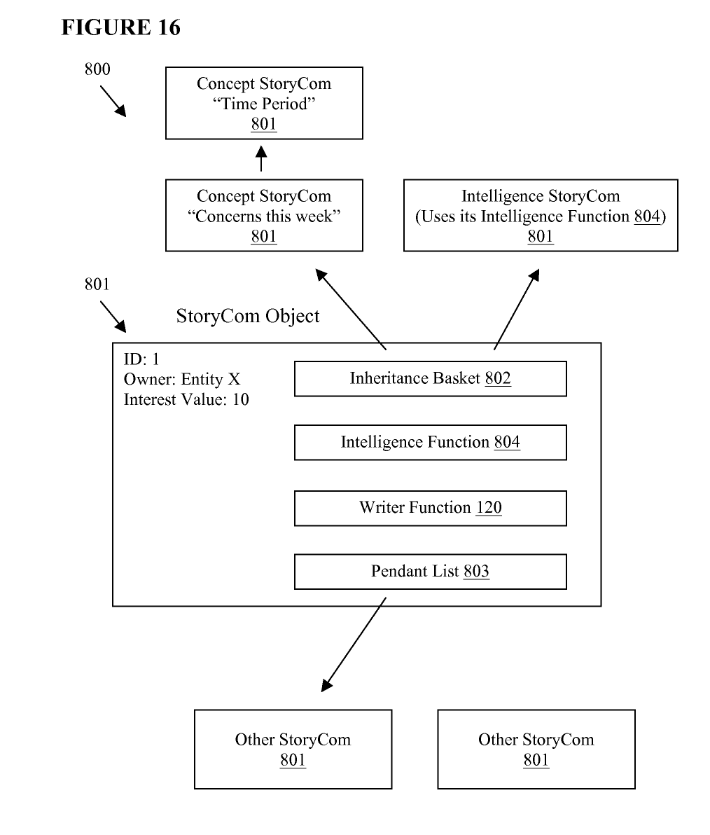

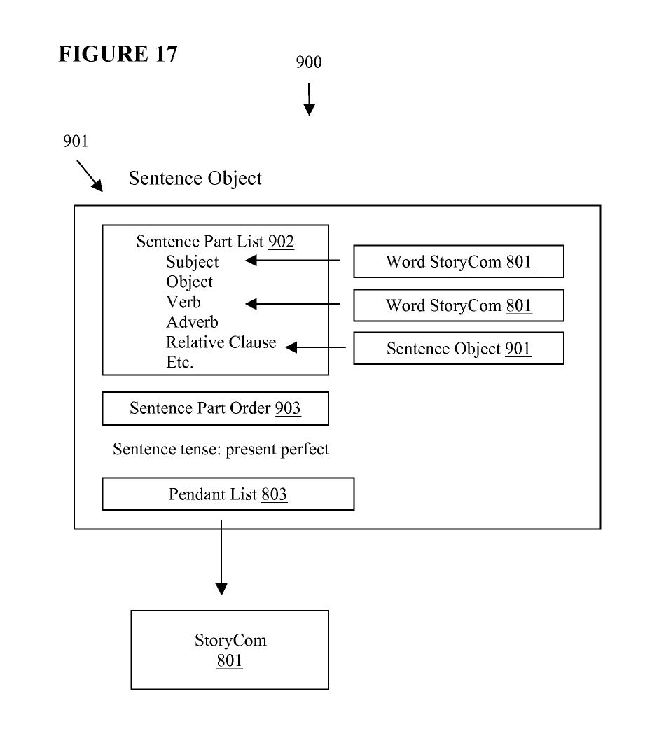

Turning back to FIG. 16, storycoms 801 are programming objects created in an object-oriented programming language. Storycom 801 is short for “story communicator,” as each storycom 801 helps to facilitate the creation of a narrative. In a preferred embodiment, there are four basic types of storycoms 801:
1. storywriter storycoms 801 that write stories, such as “player had a great performance;”
2. word storycoms 801 that write individual words, such as the verb “to be;”
3. concept storycoms 801 that hold concepts, such as “is good,” which can then be attached to other storycoms 801 (like storywriter and word storycoms 801); and
4. intelligence storycoms 801 that help alter the content of storywriter storycoms 801, as described in more detail below.

Although different in function, each storycom 801 has the same basic capabilities. Every storycom 801 includes two lists including other storycoms 801. One of the lists is called its inheritance basket 802. The inheritance basket 802 includes all of the attributes that are inherent to the storycom 801. For instance, a storywriter 120 storycom 801 about a player doing well this week would have the concept storycoms 801 for “doing well” and “concerns this week” in its inheritance basket 802. This allows other parts of the program to interact with the storycoms 801 intelligently, just as they would with the semantic element arrays.

The advantage over the array-based semantic elements stems from the fact that each concept storycom 801 includes its own inheritance basket 802, allowing for hierarchical understanding. For instance, the “concerns this week” concept storycom 801 may include a “concerns specific time period” storycom 801 in its inheritance basket 802. Each storycom 801 inherits not only what is in their inheritance basket 802, but all of the inherited properties that the storycoms 801 in their inheritance basket 802 have, and so on. Therefore, although there would be no “concerns specific time period” storycom 801 in the “player doing well this week” inheritance basket 802, the software would know that it includes that concept, since the “concerns this week” storycom 801 includes that concept in its inheritance basket 802. This makes it easy to create hierarchical concepts, and also makes things much easier to program. For instance, many baseball statistics have the attribute of being “countable” (as opposed to averages or rates). Each baseball statistic storycom 801 (which are “word” storycoms 801) adds the “countable” concept storycom 801 to its inheritance basket 802. If at some point the programmer decides that all countable stats do not require an indefinite article (unlike, e.g., “he had a 2.50 ERA”) the programmer may simply add the concept storycom 801 “doesn't need indefinite article” to the inheritance basket 802 of the “countable” concept storycom 801. Since all stats with the “countable” storycom 801 inherit everything in the “countable” storycom 801 inheritance basket 802, each of those stats now has the attribute of not needing an indefinite article.

The other list that each storycom 801 includes is a pendant list 803. These are attributes that are not inherent to the storycom 801, and can therefore change depending on how the storycom 801 is being used. For instance, there can be a storywriter 120 storycom 801 for “team did well in a certain statistical category.” If the category was “RBI,” a programmer can add an “RBI” storycom 801 to the storywriter 120 storycom 801's pendant list 803, signifying that “RBI” is the category that the storywriter 120 storycom 801 is dealing with. These pendants are specific to each storycom 801 and are not inherited like those in the inheritance basket 802.

Each storycom 801 has its own dedicated writer 120 function. For instance, the word storycom 801 “move” has a writer 120 function that conjugates the verb “move” for every possible tense and sentence construction. Storywriter 120 storycoms 801 include writer 120 functions that include the logic required to write entire stories. These writer 120 functions work the same as those used by story writers 120, phrase writers 109, and word writers 110. The advantage comes from the fact that the writer 120 function is embedded in the storycom 801 object, which allows it to fit into conceptual hierarchies. Storycoms 801 can also include intelligence functions 804, which are described in more detail below.

Storycom 801 objects carry basic values that help identify what they are. Each storycom 801 includes a unique ID number. They also can include “owners,” which signify that the storycom 801 relates to a certain entity (like a player or team). Finally, storycoms 801 include interest values 202, which work just like the interest values 202 in the story matrix 200 described above.

As shown in FIG. 17, word storycoms 801 can be strung together to create a sentence by placing them into a sentence object 901. A sentence object 901 includes a list of sentence parts, such as subject, object, preposition, punctuation, verb, auxiliary verb, etc. Each of these sentence parts, as necessary, is filled with one or more word storycoms 801. The sentence object 901 also stores the order in which the sentence parts are to be arranged in the sentence part order list. In addition, the sentence object 901 includes the tense of the given sentence.

As an example, a programmer may arrange word storycoms 801 in a sentence object 901 in the following way:
<subject>Team X (Word storycom 801)
<verb>Do (Word storycom 801)
<object>Good (Word storycom 801)

To write “Team X did well,” the above sentence object 901 needs to be in “past” tense. Once the sentence object 901 is marked as being in past tense, the writer 120 function for the verb “do” recognizes that, and write the appropriate word “did.” In addition, the “good” word storycom 801 can recognize that if it is in the “object” sentence part of a sentence object 901, it should change its text output to “well.”

Sentence objects 901 also include a pendant list 803 that stores a list of concept storycoms 801 that apply to the sentence object 901. These concepts include things such as whether the adverb in the sentence object 901 is necessary or whether the subject can be replaced by a pronoun. These attributes can be used by other functions in the program that need to interact or merge with the information contained in the sentence object 901, such as sentence combiners 1050 (described in detail below).

Sentence objects 901 do not need to be full sentences, but instead may be merely a sentence fragment. Sentence objects 901 may also include other sentence objects 901 as one of their sentence parts. These sentence objects 901 can work as relative clauses for their parent sentence object 901.

Breaking the sentence into its component parts allows future parts of the narrative to draw additional information from the sentence. For instance, whether a team name should be replaced with a pronoun might depend not only on whether the team name was mentioned in the previous sentence, but on whether it was the object or subject of that sentence.

In addition, using sentence objects 901 allows sentences to be written with word storycoms 801, which then output different text based on the intelligence contained within the word storycom 801 writer 120 function. In other words, there does not need to be different text options 130 for each tense, but instead one version that automatically adapts when the tense, or other elements, changes (examples of such changes are described below).

Finally, and most importantly, breaking the sentence into component parts allows functions to mix and match sentence objects 901 together, in a process described in more detail below.

Intelligence storycoms 801 include functions that analyze narrative situations and suggest narrative changes. Storywriter 120 storycoms 801 often have intelligence storycoms 801 in their inheritance basket 802. At the beginning of a storywriter 120 storycom 801's writer 120 function, the writer 120 function checks all the storycoms 801 in its storycom 801 object's inheritance basket 802 to see if any of them include intelligence functions 804 with narrative suggestions. In pseudo code, it looks like this:
Function writeStoryX( ) (this is the writer 120 function attached to storycom 801 StoryX)
   1. Look through my inheritance basket 802 to see if there are any storycoms 801 with intelligence functions 804
   2. If so, return information from those functions
   3. Alter my writing to incorporate the information returned by the intelligence functions 804 (optionally call a sentence combiner 1050 to help with this process)
End function

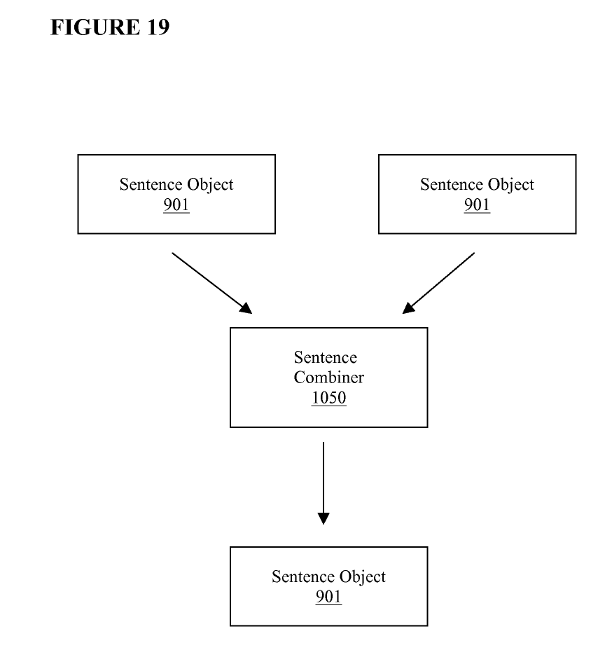

A simple example of intelligence storycoms 801 occurs when two player stories are written back-to-back, where both stories concern a player doing badly. Each of these stories include an intelligence storycom 801 in their inheritance basket 802 that deals with back-to-back player stories. When the first story is written, that intelligence storycom 801 has no effect as long as the previous story was not also about that player. However, when the second story about the player is written, the intelligence storycom 801 suggests changing the text output of the player story's storywriter 120 function. The narrative suggestions take the form of sentence objects 901 that are passed from the intelligence storycom 801 to the storywriter 120 storycom 801. For instance, in the above example of a second negative player story, the intelligence storycom 801 may return a sentence object 901 that contains the adverb “also.” If it does, the storywriter 120 function that called that intelligence storycom 801 incorporates the new sentence object 901 using a sentence combiner 1050 (FIG. 19), as described in more detail below.

Intelligence storycoms 801 are beneficial because they allow a programmer to easily create narrative flow between stories. Intelligence storycoms 801 can “centralize” things like transitions that exist at the beginning of a storywriter 120. Instead of each storywriter 120 having its own separate logic that looks to the previous parts of the narrative (checking semantic values 351), all similar storywriters 120 can share the transition logic. By centralizing the code, it makes it easier to make changes and add variety. More importantly, the transitions for multiple stories of the same type can all be held in one option list 1004 (described in detail below), which reduces the likelihood of repetition.

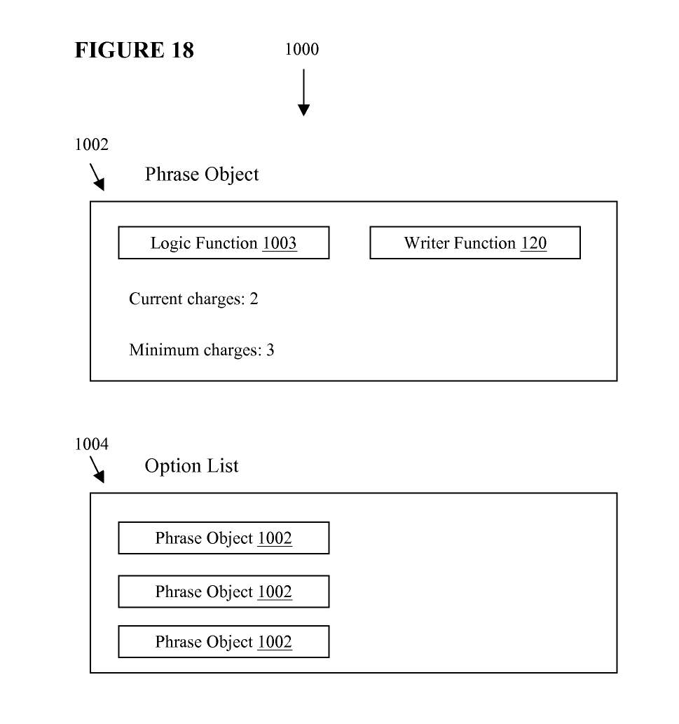

As shown in FIG. 18, the narrative generator 100 uses option lists 1004 to provide a variety of story writing options. For instance, instead of just including one piece of text, storywriters 120 may include an option list 1004 with many different suggestions. This is similar to text options 130 described above, but option lists 1004 may be more dynamic and powerful. The narrative output 151 of an option list 1004 can either take the form of raw text or sentence objects 901. In some embodiments, the option lists 1004 are used by all different types of writer 120 functions and for the narrative suggestions from intelligence functions 804.

An option list 1004 may be made up of a list of phrase objects 1002. Phrase objects 1002 are objects that include both a logic function 1003 and writer 120 function. When a phrase object 1002's logic function 1003 is called, the function looks at the semantic values 351 of other stories in the narrative to determine if it would be appropriate to call the phrase object 1002's writer 120 function. For instance, in the option list 1004 for the storyline 210 function dealing with a player's good performance, there might be one phrase object 1002 that is only appropriate if the player did well in the batting average category. Accordingly, its logic function 1003 could check the storycom 801 attached to the writer 120 function to see if it includes a “batting average” storycom 801 in its pendant list 803, signifying that it was about batting average performance. If so, it would return the value “true”, signifying that it would be appropriate to call the phrase object 1002's writer 120 function.

When a writer 120 function is using an option list 1004, it calls the logic function 1003 of every phrase object 1002 in the option list 1004. It then stores the list of every phrase object 1002 that has been cleared by its logic function 1003 to be used. The writer 120 function then typically selects the first phrase object 1002 in that list and calls the phrase object 1002's writer 120 function to get the text or sentence object 901 that the phrase object 1002's writer 120 function returns. After being used, the phrase object 1002 goes to the back of the option list 1004, so that the next time the option list 1004 is used, that phrase object 1002 will not be used unless every phrase object 1002 in front of it is not applicable (as determined by their logic functions 1003). This helps make sure that the variety in the option list 1004 is maximized. All of the phrase objects 1002 that were identified as ok to be used, but not used, would get a “charge.” This is an integer value that stores the number of times a phrase object 1002 could have been used but wasn't. After a phrase object 1002 is used, this “charge” value is set to 0.

To maximize variety further, as shown in FIG. 18, some phrase objects 1002 can be given a “minimum charge” property. A phrase object 1002 with a given minimum charge property cannot be used (even if it is at the top of the list) unless its “charge” value was at or above its minimum number of charges. A minimum charge may be beneficial when there are phrase objects 1002 targeted to specific situations that do not come up very often. Often, these phrase objects 1002 are unique and memorable. However, because they are not triggered very often, they will tend to move up towards the top of the list (since the more generic phrase objects 1002 will be getting used more often, meaning they will tend to be at the bottom of the list). By setting a minimum charge amount for these unique phrase objects 1002, a programmer can make sure that readers will get the “generic” version a given number of times before the more memorable version is repeated again. This prevents readers from seeing the same thing every time a particular situation occurs. Programmers can also set the minimum charge property to an impossibly high number, to create “one off” phrase objects 1002 that will only be triggered one time and then never run again.

Turning to FIG. 19, sentence combiners 1050 are functions that take two or more sentence objects 901 and combine them into one sentence object 901, using sentence parts from each sentence object 901. These sentence combiners 1050 allow intelligence storycoms 801 and storywriter 120 storycoms 801 to work together. When a function, such as a storycom 801's intelligence function, creates a sentence object 901, it can add concept storycoms 801 to the sentence object 901's pendant list 803. One of the concepts storycoms 801 it can add, concerns what sentence combiner 1050 can be used to merge its sentence object 901 with a sentence object 901 from another function.

For instance, one sentence combiner 1050 deals with “subject and auxiliary verb” sentence objects 901. An example of this type of sentence object 901 would say, for instance “The offensive explosion helped;” with “the offensive explosion” working as the subject and “helped” working as an auxiliary verb. This sentence object 901 could be combined with a sentence object 901 that said “Team X moved up in the standings this week”, to form the sentence “The offensive explosion helped Team X move up the in the standings this week.” The sentence combiner 1050, in this case, would turn the subject of the second sentence object 901, “Team X”, into the object of the new combined sentence object 901, and change the verb “move” to its infinitive form.

The second sentence object 901 (“Team X moved up in the standings this week”) would need to have the storycom 801 that indicated it could be used with a “subject and auxiliary object” sentence combiner 1050. Typically, a given storyline writer 107 would be getting a list of possible sentence objects 901 from its intelligence storycoms 801. This list of sentence objects 901 would be checked against the sentence object 901 the storyline writer 107 wanted to write, to see which sentence objects 901 had sentence combiners 1050 in common, and could therefore be joined together.

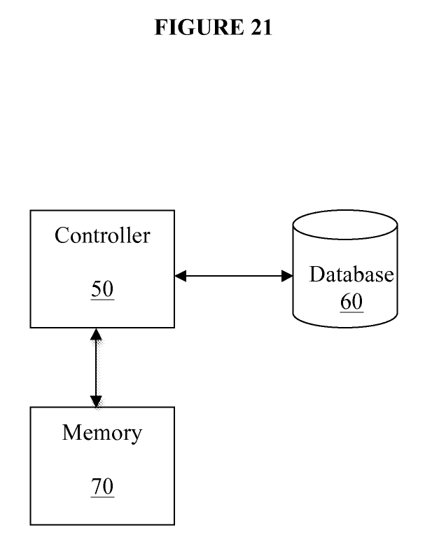

As shown in FIG. 21, aspects of the systems and methods described herein are controlled by one or more controllers 50. The one or more controllers 50 may be adapted run a variety of application programs, access and store data, including accessing and storing data in associated databases 60, and enable one or more interactions as described herein. Typically, the one or more controllers 50 are implemented by one or more programmable data processing devices. The hardware elements, operating systems, and programming languages of such devices are conventional in nature, and it is presumed that those skilled in the art are adequately familiar therewith.

For example, the one or more controllers 50 may be a PC based implementation of a central control processing system utilizing a central processing unit (CPU), memory 70 and an interconnect bus. The CPU may contain a single microprocessor, or it may contain a plurality of microprocessors for configuring the CPU as a multi-processor system. The memory 70 include a main memory, such as a dynamic random access memory (DRAM) and cache, as well as a read only memory, such as a PROM, EPROM, FLASH-EPROM, or the like. The system may also include any form of volatile or non-volatile memory 70. In operation, the memory 70 stores at least portions of instructions for execution by the CPU and data for processing in accord with the executed instructions.

The one or more controllers 50 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 50 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller 50. For example, the one or more controllers 50 may include a graphics subsystem to drive the output mechanism. The links of the peripherals to the system may be wired connections or use wireless communications.

Although summarized above as a PC-type implementation, those skilled in the art will recognize that the one or more controllers 50 also encompasses systems such as host computers, servers, workstations, network terminals, and the like. Further one or more controllers 50 may be embodied in a device, such as a mobile electronic device, like a smartphone or tablet computer. In fact, the use of the term controller 50 is intended to represent a broad category of components that are well known in the art.

Hence aspects of the systems and methods provided herein encompass hardware and software for controlling the relevant functions. Software may take the form of code or executable instructions for causing a controller 50 or other programmable equipment to perform the relevant steps, where the code or instructions are carried by or otherwise embodied in a medium readable by the controller 50 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 70 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 50 can read programming code and/or data. Many of these forms of computer readable media may be involved in carrying one or more sequences of one or more instructions to a processor for execution.

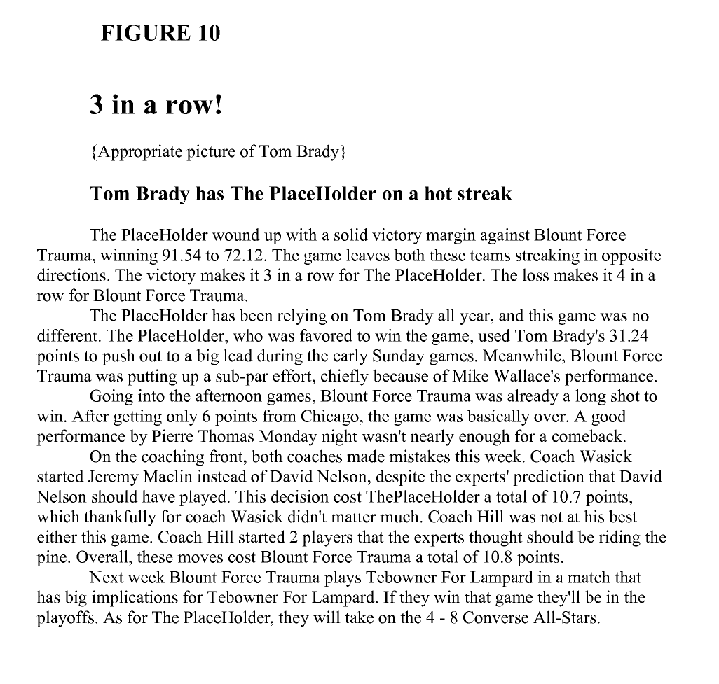

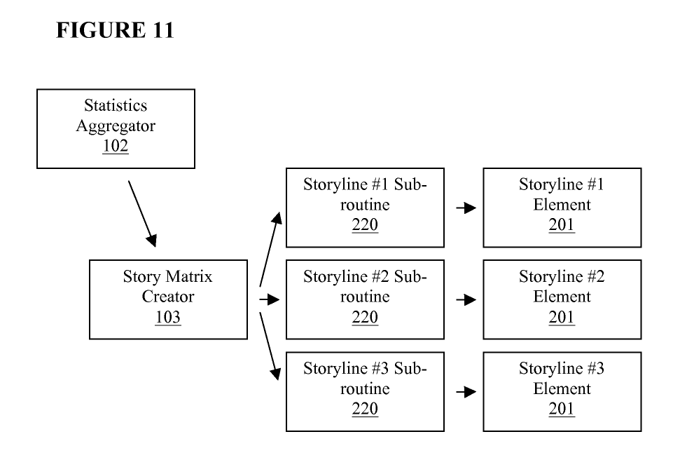

FIG. 10 is an example of a complete narrative produced by a narrative generator as presented herein. Of course, no single example can capture the wide variation in output that can be provided, but those skilled in the art will recognize the advantages of the narrative generator based on the example provided in FIG. 10.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system comprising:
a processor;
a memory coupled to the processor, wherein the memory is configured to store program instructions executable by the processor;
wherein in response to executing the program instructions, the processor is configured to:
access a database storing a plurality of data elements;
assign each data element an associated interest value and one or more semantic values;
select one or more data elements based on interest values and semantic values;
select one or more topic paragraph creators associated with selected elements, wherein each paragraph creator acts on data elements with complimentary semantic values;
enact a filter level that excludes data elements from use in the one or more topic paragraph creators based on interest vales;
implement a plurality of writers to create a plurality of narrative blocks related to the selected topic paragraph creators, each writer including a plurality of text options from which a narrative block is constructed, wherein text options are selected for inclusion in a given narrative bock are based at least in part on reference to a narrative companion array and a grammar companion array, wherein the narrative companion array includes semantic values corresponding to the data elements included in any of the plurality of narrative blocks, wherein the grammar companion array includes grammar values associated with the text options included in the plurality of narrative blocks.

2. The system of claim 1 wherein the plurality of writers include fixed text options.

3. The system of claim 1 wherein the plurality of writers include variable text options.

4. The system of claim 1 wherein the plurality of writers include calls to additional writers.

5. The system of claim 1 wherein the processor is further configured to identify a data element to be associated with a headline.

6. The system of claim 5 wherein the processor considers the interest value of the data elements as well as previously used headlines in identifying the data element to be associated with the headline.

7. The system of claim 6 wherein the processor is further configured to identify a headline from a plurality of potential headlines, wherein the identified headline includes at least one common semantic value corresponding to a semantic value associated with the identified data element.

8. The system of claim 1 wherein the processor is further configured to identify a visual media element including meta-data corresponding to a semantic value associated with the identified data element.

9. The system of claim 1 wherein the processor is further configured to identify a global theme by identifying recurring semantic values in the stored data elements.

10. The system of claim 1 wherein the processor is further configured to provide a custom writer through which a user may provide one or more custom data elements for inclusion in the database.

11. The system of claim 1 wherein the processor is further configured to provide a sidebar writer adapted to provide a visual representation of one or more of the data elements.

12. The system of claim 1 wherein the processor is further configured to identify a data element for which additional user input is desired, present a question to a user through an output mechanism, receive a corresponding user input through an input mechanism, and incorporate the user input into a narrative block.

13. The system of claim 1 wherein each of the plurality of writers is a story communicator, wherein each story communicator includes:
an associated interest value;
an inheritance basket of properties applicable to the specific story communicator and further applies to any other story communicator that references the specific story communicator;
a pendent list of properties applicable to the specific story communicator that do not apply to any other story communicator that references the specific story communicator; and
a writer function that conjugates any verb included in the story communicator.

14. The system of claim 13 wherein the processor is further configured to provide a plurality of sentence objects, each sentence object including a plurality of sentence parts, wherein the sentence parts call corresponding story communicators based, at least in part, on the associated interest value.

15. The system of claim 1 wherein each writer selects text options for inclusion in the corresponding narrative block without reference to another writer.

16. The system of claim 1 wherein each text option is associated with a charge expressed an integer value that counts the number of times the text option could have been used, but was not.

17. The system of claim 16 wherein one or more of the text options has a minimum charge required in order to be selected.

18. A system comprising:
a processor;
a memory coupled to the processor, wherein the memory is configured to store program instructions executable by the processor;
wherein in response to executing the program instructions, the processor is configured to:
provide a plurality of story communicators, wherein each story communicator includes:
an associated interest value;
an inheritance basket of properties applicable to the specific story communicator and further applies to any other story communicator that references the specific story communicator;
a pendent list of properties applicable to the specific story communicator that do not apply to any other story communicator that references the specific story communicator; and
a writer function that conjugates any verb included in the story communicator; and
provide a plurality of sentence objects, each sentence object including a plurality of sentence parts, wherein the sentence parts call corresponding story communicators based, at least in part, on the associated interest value.

19. The system of claim 18 wherein the processor is further configured to create a plurality of narrative blocks, each formed from a plurality of sentence objects.

20. The system of claim 18 wherein the inheritance basket of a first story communicator includes a second story communicator.
